(19) United States
(12) Patent Application Publication
(10) Pub. No.: US 2026/0065298 A1
(43) Pub. Date: Mar. 5, 2026

(54) DETERMINING FRAUDULENT SURVEY RESPONSES TO DIGITAL SURVEYS USING RULE-BASED MODELS AND MACHINE-LEARNING MODELS

(71) Applicant: Qualtrics, LLC, Provo, UT (US)

(72) Inventors: Emily Geisen, Durham, NC (US); Grzegorz Chlebus, Krakow (PL); Philip Beck, Seattle, WA (US); Joey Shearer, Orem, UT (US); Harika Kalvakolan, Redmond, WA (US); Anmol Matada, Kirkland, WA (US); David Cortes Rivera, Krakow (PL); Maksym Titov, Krakow (PL); Joanna Gagatko, Krakow (PL)

(21) Appl. No.: 18/824,067

(22) Filed: Sep. 4, 2024

(51) Int. Cl. G06Q 30/018; G06N 20/00

(52) U.S. Cl. CPC G06Q 30/0185; G06N 20/00

(57) ABSTRACT

The present disclosure relates to systems, non-transitory computer-readable media, and methods for generating a fraud score for survey response data and updating a dataset of responses of a digital survey. In particular, in one or more embodiments, the disclosed systems utilize a fraud indicator identifying algorithm to determine fraud indicators and generate a fraud score for the survey response data. In addition, in one or more embodiments, the disclosed systems utilize a fraudulent response identifying machine-learning model to generate a fraud score. The disclosed systems then utilize the fraud score to generate a label for survey response data and update a dataset of responses to a digital survey based on the label. In one or more embodiments, based on the disclosed systems generating a fraudulent label for the survey response data, the disclosed systems remove survey response data from the dataset.

### BACKGROUND

Recent years have seen significant improvements in providing targeted feedback opportunities in many different scenarios via digital surveys. For example, many systems identify and target certain audiences, then provide various feedback opportunities (e.g., digital surveys) to gain insight and data relevant to the target demographic. For example, some conventional feedback systems often utilize various algorithms or models to identify the target audiences and provide digital surveys aimed at gathering information from the target demographic, often offering an incentive for providing feedback. However, conventional feedback systems have a number of technical deficiencies with regard to identifying fraudulent feedback, particularly with regard to bad actors attempting to capitalize on an incentive for providing feedback.

For example, conventional feedback systems often suffer from inaccurate data gathering due to bad actors. While conventional systems gather information from target audiences, they fail to identify fraudulent responses. Bad actors infiltrate conventional feedback systems to provide compromised, fraudulent, or irrelevant information as answers and responses to a feedback solicitation. To illustrate, some bad actors generate scripts for incentive-based digital surveys that generate multiple responses to the digital survey in attempt to capitalize on the incentives offered for completing the digital survey, and conventional feedback systems are unable to accurately distinguish between a human-generated response and a bot-generated response, particularly responses from sophisticated scripts. As another illustration, some bad actors provide fraudulent information in order to post as a member of the target audience so they can gain access to the survey, typically also in attempt to capitalize on an incentive. These impersonated responses often contain only slight indications of fraud, and conventional systems cannot identify them as fraudulent.

In addition, because conventional feedback systems are unable to identify fraudulent feedback, these conventional feedback systems fail to provide accurate feedback data. Specifically, because conventional systems include fraudulent data in datasets, they do not provide accurate data from the targeted audience for use in downstream operations. For example, failing to identify fraudulent feedback results in additional inaccuracies as the feedback is analyzed, as attempts to gain insights and information based on the fraudulent data results in inaccuracies. In addition, conventional feedback systems also miss valuable patterns or trends that are masked or skewed by the fraudulent data. These along with additional problems and issues exist with regard to conventional feedback systems.

### BRIEF SUMMARY

Embodiments of the present disclosure provide benefits and/or solve one or more of the foregoing or other problems in the art with systems, non-transitory computer-readable media, and methods for detecting fraudulent data in survey response data of digital surveys for intelligently updating a dataset of responses during data scrubbing operations. For example, in response to a data scrub request, the disclosed systems utilize rule-based models with large language models to determine fraud indicators from survey response data and generate a fraud score based on the fraud indicators. In some embodiments, the disclosed systems also utilize a trained machine-learning model to generate a fraud score for survey response data. The disclosed systems can then utilize the fraud score to generate a label for the survey response data and update a dataset of responses of the digital survey based on the label. In one or more embodiments, the disclosed systems update a plurality of responses of the digital survey by removing the survey response data from the plurality of responses when the label indicates a probability that the survey response data is fraudulent.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a fraudulent response determination system can operate in accordance with one or more embodiments.

FIG. 2 illustrates an example sequence flow for a fraudulent response determination system generating a fraud score for survey response data and updating a dataset of responses of a digital survey in accordance with one or more embodiments.

FIG. 3 illustrates an example flowchart for utilizing a fraud indicator identification algorithm to identify fraud indicators to generate a fraud score and update a dataset of responses of a digital survey in accordance with one or more embodiments.

FIG. 4 illustrates an example diagram for determining one or more fraud indicators from survey response data in accordance with one or more embodiments.

FIG. 5 illustrates an example diagram for generating a prompt to generate an output based on survey response data and providing the prompt to a large language model to generate the output in accordance with one or more embodiments.

FIG. 6 illustrates6 an example diagram for utilizing a fraudulent-response-identifying machine-learning model to generate a fraud score and update a dataset of responses of a digital survey in accordance with one or more embodiments.

FIGS. 7A-7B illustrate an example diagram for generating a training dataset and utilizing the training dataset to train a fraudulent-response-identifying machine-learning model in accordance with one or more embodiments.

FIGS. 8A-8B illustrate example graphical user interfaces for receiving data scrub requests and managing responses of a digital survey in accordance with one or more embodiments.

FIG. 9 illustrates an example series of acts for generating a fraud score and updating a dataset of responses for a digital survey in accordance with one or more embodiments.

FIG. 10 illustrates a block diagram of an example computing device for implementing one or more embodiments of the present disclosure.

FIG. 11 illustrates a network of a digital survey management system in accordance with one or more embodiments.

### DETAILED DESCRIPTION

This disclosure describes one or more embodiments of a fraudulent response determination system that utilizes algorithms and machine-learning models to detect fraudulent response data using various rule-based and machine-learning models. For example, the, fraudulent response determination system generates a fraud score indicating a probability that a digital survey response is fraudulent and intelligently updates datasets of responses for the digital survey. Specifically, the fraudulent response determination system generates a label for a response of the digital survey response based on the fraud score. The fraudulent response determination system can then update a dataset of responses for the digital survey, such as by removing the digital survey response from the dataset if the label indicates it is fraudulent.

In one or more embodiments, the fraudulent response determination system utilizes algorithms to identify fraud in survey response data corresponding to the response for the digital survey. Specifically, the fraudulent response determination system utilizes a fraud indicator identification algorithm to identify fraud indicators that suggest that survey response data is fraudulent based on various content or context characteristics of the survey response data. The fraudulent response determination system can then generate the fraud score based on the fraud indicators, such as by generating an indicator score for each fraud indicator and generating the fraud score from the indicator scores.

In addition to utilizing algorithms to identify fraud indicators, in one or more embodiments, the fraudulent response determination system utilizes large language models to identify fraud indicators and other information from survey response data. The fraudulent response determination system can generate a prompt for a large language model comprising survey response data and instructions to generate output comprising fraud indicators from survey response data. In some cases, the fraudulent response determination system utilizes a large language model to identify demographic information by generating a prompt comprising the survey response data and instructions to identify demographic information and providing the prompt to a large language model to generate the demographic information from the survey response data. In additional embodiments, the fraudulent response determination system utilizes a large language model for detecting inconsistencies in response data.

In addition, in one or more embodiments, the fraudulent response determination system utilizes a trained machine-learning model to identify fraud in survey response data by generating a fraud score. In particular, the fraudulent response determination system utilizes a trained fraudulent-response-identifying machine-learning model to generate the fraud score for survey response data. In some cases, the fraudulent response determination system generates a training dataset to train the fraudulent-response-identifying machine-learning model by annotating survey response data with fraud determination indicators. Additionally, the fraudulent response determination system utilizes the training dataset to update parameters of the fraudulent-response-identifying machine-learning model.

The fraudulent response determination system analyzes survey response data at varying points during the digital survey. For example, in some embodiments, the fraudulent response determination system identifies fraud indicators or provides the survey response data as the fraudulent response determination system receives survey response data from a respondent client device (e.g., in real-time). In one or more embodiments, the fraudulent response determination system receives a data scrub request (e.g., from an administrator client device) and identifies fraud indicators (e.g., with the fraud indicator identifying algorithm) or provides the survey response to a fraudulent-response-identifying algorithm as part of a rule-based model. Moreover, in some cases, the fraudulent response determination system can receive a data scrub request based on the amount of digital survey responses, such as when the digital survey satisfies a digital survey completion threshold.

As mentioned, in some embodiments the fraudulent response determination system generates a label for survey response data. Specifically, the fraudulent response determination system generates a label that identifies whether survey response data is fraudulent. For example, the fraudulent response determination system generates a fraudulent label when a fraud score indicates that the survey response data is fraudulent. In some cases, the fraudulent response determination system identifies a fraudulent response indicator that indicates the survey response data is fraudulent and generates a fraud score for the survey response data that satisfies the fraud response threshold to generate a fraudulent label. Furthermore, the fraudulent response determination system utilizes the label to modify a dataset, such as by removing response data labeled as fraudulent from the dataset for various downstream operations.

The fraudulent response determination system provides a variety of technical advantages relative to conventional systems. For example, the fraudulent response determination system improves accuracy relative to conventional feedback systems as the fraudulent response determination system uses multiple modalities to accurately distinguish between legitimate survey responses and those from bad actors attempting to capitalize on incentive-based digital surveys or from bot-generating responses. Specifically, as mentioned, many bad actors often utilize scripts and other computer-based processes to imitate legitimate response data by masking location data (e.g., via the use of VPNs). Accordingly, the fraudulent response determination system utilizes a number of different digital content analysis operations (e.g., rule-based models and machine-learning models) to generate fraud scores for survey response data from digital surveys indicating the likelihood of the survey response data being fraudulent. For example, by utilizing large language models and a fraud indicator identifying algorithm to determine fraud indicators in survey response data of survey responses, the fraudulent response determination system generates consistent and accurate fraud scores reflecting the probability of fraud in the survey response data. In additional embodiments, the fraudulent response determination system utilizes a fraudulent-response-identifying machine-learning model that is trained to generate fraud scores for survey response data and accurately identify fraudulent survey response data from survey responses.

Additionally, since the fraudulent response determination system generates accurate fraud scores, the fraudulent response determination system also improves accuracy of a digital survey dataset relative to conventional feedback systems. In particular, the fraudulent response determination system uses the accurate fraud scores to update a dataset of responses for a digital survey by removing (e.g., via data scrubbing operations) fraudulent or irrelevant data. The fraudulent response determination system thus improves the quality of the dataset, which allows the fraudulent response determination system to update the accuracy of the machine-learning models (e.g., through additional training) and/or downstream operations involving the dataset. Indeed, by removing or moving fraudulent data, evaluations performed using the dataset results in more accurate insights and analysis and improved machine-learning models.

Moreover, as the fraudulent response determination system can easily identify and remove fraudulent survey response data, the fraudulent response determination system improves efficiency relative to conventional feedback systems. In particular, in contrast to conventional systems that use excess computing and processing power reviewing survey responses or processing excess data (e.g., due to their inability to identify fraudulent response data), the fraudulent response determination system can remove fraudulent survey response data from a dataset in response to a data scrub request. In addition, the fraudulent response determination system can remove survey response data with fewer user interactions overall in response to a data scrub request via a graphical user interface that indicates a request to scrub data in a dataset.

As illustrated by the foregoing discussion, the present disclosure utilizes a variety of terms to describe features and advantages of the fraudulent response determination system. As used herein, the term “digital survey” refers to a digital collection of questions and associated responses. For example, in one embodiment, a digital survey includes digital question identifiers organized according to a specific question flow, where each question identifier refers to question text, question rules (e.g., “select all that apply,” “choose only one”), and is tied or mapped to various response identifiers. The response identifiers refer to response text and are associated with a presentation order and other formatting. When a user completes a digital survey, one or more systems described herein generate one or more data items including information on the survey taker (e.g., a user ID, a survey completion timestamp), and information including the user's selected responses within the survey.

In addition, as used herein, the term “response” refers to a collection or compilation of answers, information, and data for a digital survey. In particular, the term “response” refers to various user input as answer to prompts or questions of a digital survey, along with other information or data collected as part of administering the survey, such as demographic information, user identification data, client device data, identification data, or survey deployment data. For example, a response may include, but is not limited to, one or more of: question information associated with the one or more digital surveys, response information associated with the one or more digital surveys, user-selected responses associated with the one or more digital surveys, user information associated with users who responded to questions from the one or more digital surveys, deployment information associated with the one or more digital surveys, and question flow information associated with the one or more digital surveys.

As used herein the term “survey response data” refers to data associated with a response to a digital survey. Specifically, the term “survey response data” refers to data or a portion of data collected from a response of a digital survey. For example, survey response data can represent the specific pieces of information provided by participants when responding to a digital survey (e.g., answers, information, observations, insights, opinions) or data collected as a user interacts with the digital survey to provide the response. As an illustration, survey response data can comprise, but is not limited to, text responses (e.g., to open-ended questions), options selected of the digital survey, user identification information, timing of question selection as a user responds to the digital survey, or respondent client device information associated with a respondent client device on which a user completes the digital survey.

As used herein, the term “data scrub request” refers to an instruction or command to perform a task or operation to remove data. In particular, the term “data scrub request” can include a process to identifying fraud, duplicates, errors, inconsistencies, or inaccuracies in data and removing the data from a storage location, dataset, or database. For example, a data scrub request can provide instructions to identify and remove survey response data that is likely fraudulent or duplicative from a plurality of survey responses for a digital survey. In some embodiments, an administrator client device can submit a data scrub request based on identifying that a survey is a threshold percent completed.

As used herein, the term “fraud indicator” refers to a measurable variable or parameter that provides information about a likelihood that survey response data is fraudulent. Specifically, the term “fraud indicator” can include a classification for survey response data (or a portion of survey response data) that indicates that the survey response data may be fraudulent. For example, a fraud indicator identifies that survey response data, or a portion of the survey response data, satisfies rules for identifying fraudulent survey response data. As an illustration, a fraud indicator can be assigned to survey response data when a sign, measure, cue, criteria, parameter, or pattern that, when found in survey response data or according to contextual information for the survey response data, indicates the survey response data or the response was manipulated, falsified, or misrepresented, compromising the integrity and reliability of the response. In some embodiments, a fraud indicator indicates a likelihood of data being irrelevant or not useful.

As used herein, the term “fraudulent response indicator” refers to a measurable variable or parameter that, when identified in survey response data, indicates that that the survey response data is fraudulent. In particular, the term “fraudulent response indicator” is a signal that is strongly associated with fraudulent survey response data so that, when identified in survey response data, indicate that the survey response data was manipulated, falsified, or misrepresented. For example, a fraudulent response indicator indicates that survey response data is not informative or does not provide valuable insight because the survey response data is likely fraudulent.

As used herein, the term “attributes” refers to characteristics or properties that define and describe elements within data. In particular, the term “attributes” refers to characteristics of survey response data that provides information or indications about the survey response data. For example, attributes can include individual pieces of data from the survey response data that assist in analyzing survey response data to help identify and differentiate between fraudulent and non-fraudulent survey response data.

As used herein, the term “fraud score” refers to a classification or metric indicating whether survey response data is fraudulent. In some embodiments, a fraud score comprises a value indicating a likelihood that the survey response data is inauthentic, artificially generated (e.g., using a large language model), duplicative, or otherwise does not convey an authentic response to the digital survey. For example, a fraud score can comprise a score (e.g., a number, a fraction, or other numerical indicators) indicating a degree to which a fraudulent-response-identifying machine-learning model predicts survey response data is fraudulent. In other embodiments, the fraud indicator could be a classifier, such as a “0” or a “1” or a “yes” or “no,” indicating that the survey response data is or is not fraudulent.

As used herein, the term “indicator score” refers to a classification or metric for a fraud indicator. In particular, the term “indicator score” refers to a value indicating a likelihood that the fraud indicator denotes fraudulent activity. For example, an indicator score can be a higher for a fraud indicator that indicates a higher likelihood of fraud. In one or more embodiments, indicator scores for a plurality of fraud indicators can be combined or summed together to generate a fraud score (e.g., an overall score) for survey response data.

As used herein, the term “label” refers to a word, phrase, or other identifier that identifies or indicates a designation for survey response data or a response. In particular, the term “label” refers to a word, phrase, or identifier associated with survey response data or a response of a digital survey in response to a determination of fraud. For example, a label can indicate a fraud determination for survey response data based on a fraud score. The term “fraudulent label” can refer to survey response data with a fraud score indicates is likely fraudulent. The term “suspicious label” can refer to survey response data that a fraud score indicates is may be fraudulent. The term “mild label” can refer to survey response data with a fraud score that indicate it is likely not fraudulent (e.g., the response is likely valid).

As used herein, the term “dataset” refers to a collection of data items. In particular, the term data set can include data items from one or more sources. Additionally, a data set can exist in one or more formats. For example, a dataset can be a comma-separated values file (e.g., a CSV file). Additionally, or alternatively, a dataset can be a linked list, a hash table, a text file (e.g., delimited by any specified character), or any other type of data file. In one or more embodiments, the fraudulent response determination system receives data sets via file transfer (e.g., according to any of various protocols such as SFTP), or any other type of data transfer method.

As used herein, the term “digital survey completion threshold” refers to a level or benchmark that indicates that a digital survey meets criteria for an amount of completion. Specifically, the term “digital survey completion threshold” can refer to a number of responses for a digital survey or an amount of survey response data received by a digital survey management system. Based on the digital survey completion threshold, a digital survey management system can perform additional actions, such as triggering a data scrub of responses to a digital survey.

As used herein, the term “prompt” refers to an input that serves as a starting point or context for generating a response from a large language model. In particular, the term “prompt” can refer to a text input comprising a question, statement, partial sentence designed to elicit a relevant, coherent, and contextually appropriate output based on the training data of the large language model. For example, a prompt includes survey response data and instructions for a large language model to generate an output that includes identification of certain information from the survey response data. In some case, a prompt can instruct a large language model to identify demographic information and/or fraud indicators from survey response data.

As used herein, the term “demographic information” relates to data indicating characteristics of a survey respondent. In particular, the term “demographic information” refers to information within survey response data that indicates characteristics of a survey respondent. For example, demographic information can identify details of a respondent that identify categories or classifications for the respondent. As an illustration, demographic information can include, but is not limited to, age, gender, income, education level, occupation, marital status, ethnicity, and geographic location.

As used herein, the term “fraud indicator identification algorithm” refers to a computer-based model including a set of processing instructions designed to identify fraud indicators. Specifically, the term “fraud indicator identification algorithm” refers to a set of rules or instructions that can determine fraud indicators from survey response data. For example, a fraud indicator identification algorithm identifies fraud indicators by analyzing survey response data to determine information or data in survey response data that corresponds to one or more fraud indicators programed in the fraud indicator identification algorithm.

In addition, as used herein, the term “machine-learning model” refers to a computer algorithm or a collection of computer algorithms that automatically improve for a particular task through iterative outputs or predictions based on the use of data. For example, a machine-learning model can utilize one or more learning techniques to improve accuracy and/or effectiveness. Example machine-learning models include various types of neural networks, decision trees, support vector machines, linear regression models, and Bayesian networks. In some cases, a machine-learning model can be a “fraudulent-response-identifying machine-learning model.” As used herein, the term “fraudulent-response-identifying machine-learning model” refers to a machine-learning model trained or used to detect fraudulent survey response data. Specifically, the term “fraudulent-response-identifying machine-learning model” refers to a trained machine-learning model that generates a fraud score for survey response data indicating a likelihood that the survey response data is fraudulent. For example, the fraudulent-response machine-learning model can generate accurate fraud scores for survey response data based on training with a data set comprising annotated survey response data.

Relatedly, the term “neural network” refers to a machine-learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., interactions and/or interaction contexts) based on a plurality of inputs provided to the neural network. In some cases, a neural network refers to an algorithm (or set of algorithms) that implements deep learning techniques to model high-level abstractions in data. A neural network can include various layers, such as an input layer, one or more hidden layers, and an output layer that each perform tasks for processing data. For example, a neural network can include a deep neural network, a convolutional neural network, a transformer neural network, a recurrent neural network (e.g., an LSTM), a graph neural network, or a generative adversarial neural network. Upon training, such a neural network may become a machine-learning model.

In addition, as used herein, the term “large language model” refers to a machine-learning model trained to perform computer tasks to generate or identify interactions from unstructured text. In particular, a large language model can be a neural network (e.g., a deep neural network or a transformer neural network) with many parameters trained on large quantities of data (e.g., unlabeled text) using a particular learning technique (e.g., self-supervised learning). For example, a large language model can include parameters trained to generate outputs (e.g., interaction outputs, interaction context outputs) based on prompts and/or to identify interactions based on various contextual data, including graph information from a knowledge graph and/or historical user account behavior. In some cases, a large language model comprises various commercially available models such as, but not limited to, GPT (e.g., GPT 3.5, GPT 4), ChatGPT, Llama (e.g., Llama2-7B, Llama 3), BERT, Claude, or Cohere.

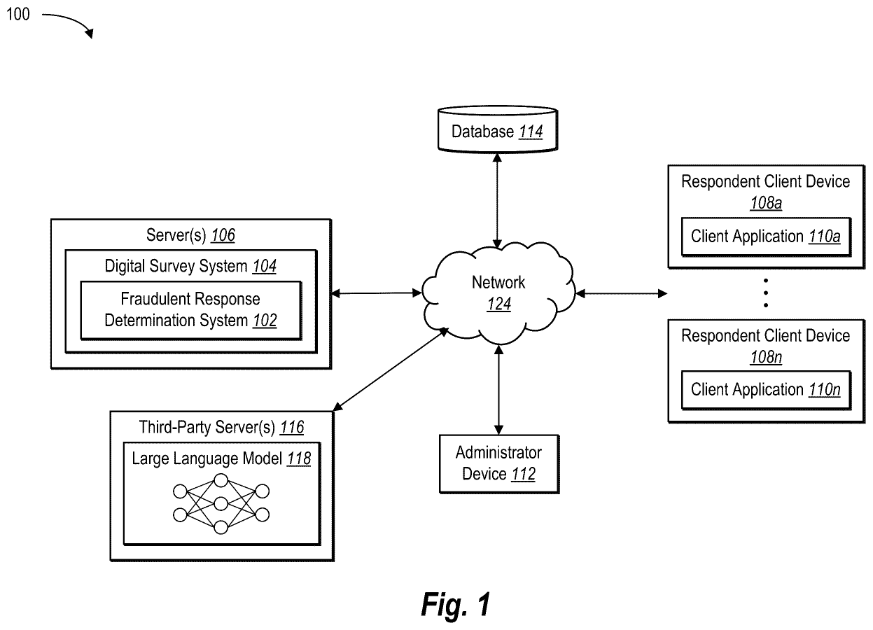

Additional details regarding the fraudulent response determination system will now be provided with reference to the figures. For example, FIG. 1 illustrates a block diagram of a system environment for implementing a fraudulent response determination system 102 in accordance with one or more embodiments. An overview of the fraudulent response determination system 102 is described in relation to FIG. 1. Thereafter, a more detailed description of the components and processes of the fraudulent response determination system 102 is provided in relation to the subsequent figures.

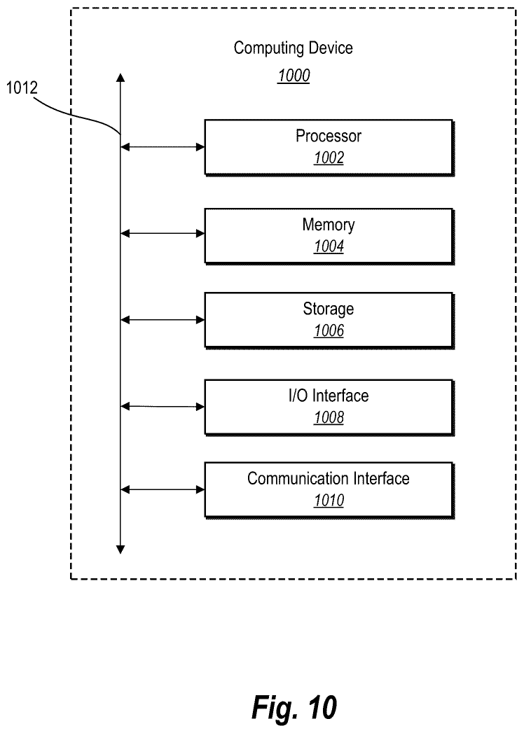

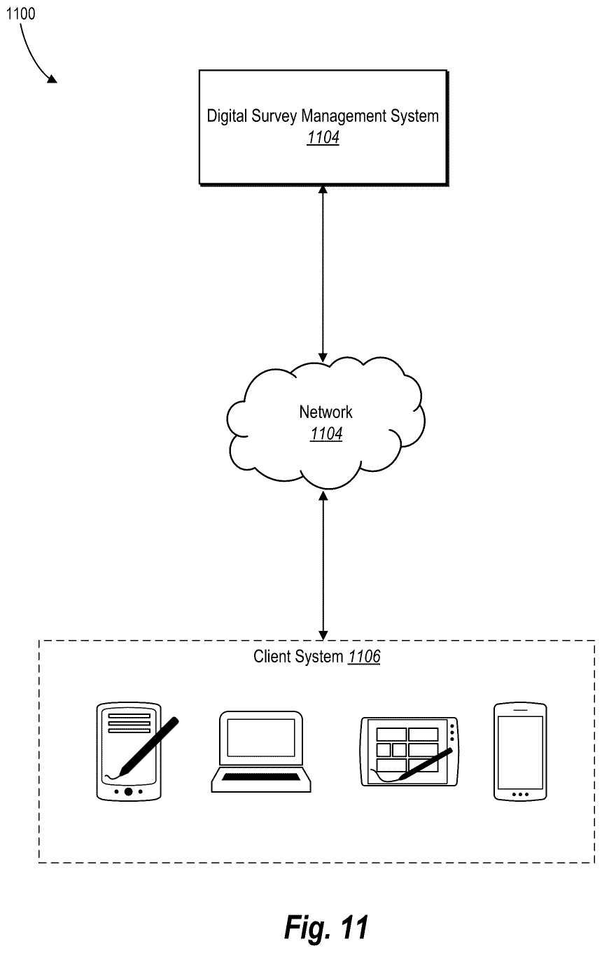

As shown, the environment 100 includes server(s) 106, database 114, respondent client device(s) 108a-108n, and administrator client device 112. Each of the components of environment 100 can communicate via network 124, and network 124 can be any suitable network over which computing devices can communicate. Example networks are discussed in more detail below in relation to FIGS. 10-11.

As mentioned above, environment 100 includes respondent client device(s) 108a-108n and an administrator client device 112. Respondent client device(s) 108a-108n may be associated with respondents of digital surveys and administrator client device 112 may be associated with an administrator of the digital survey system 104 and/or the fraudulent response determination system 102. The respondent client device(s) 108a-108n or the administrator client device 112 can be one of a variety of computing devices, including a smartphone, a tablet, a smart television, a desktop computer, a laptop computer, a virtual reality device, an augmented reality device, or another computing device as described in relation to FIGS. 10-11. The respondent client device(s) 108a-108n and the administrator client device 112 can communicate with the server(s) 106 via network 124. For example, the respondent client device(s) 108a-108n or the administrator client device 112 can receive user input (e.g., responses to digital surveys) from a user interacting with the respondent client device(s) 108a-108n (e.g., via the client application 110a-110n) or the administrator client device 112 to, for instance, select interface elements to interact with a digital survey of the digital survey system. In addition, the fraudulent response determination system 102 or the server(s) 106 can receive information or data relating to various interactions and/or user interface elements based on the input received by the respondent client device(s) 108a-108n or the administrator client device 112.

As shown, the respondent client device(s) 108a-108n can include a client application 110a-110n. In particular, the client application 110a-110n may be a web application, a native application installed on the respondent client device(s) 108a-108n (e.g., a mobile application, a desktop application, etc.), or a cloud-based application where all or part of the functionality is performed by the server(s) 106. Based on instructions from the client application(s) 110a-110n, the respondent client device(s) 108a-108n can present or display information, including a user interface for interacting with digital surveys. Using the client application, the respondent client device(s) 108a-108n can perform (or request to perform) various operations, such as rendering graphical user interfaces for receiving input associated with a digital survey or administration (or management of) a digital survey. Though not shown, the administrator client device 112 can include a client application that allows for or provides specific functionality for an administrator of the digital survey system 104 or the fraudulent response determination system 102.

As illustrated in FIG. 1, the environment 100 also includes the server(s) 106. The server(s) 106 may generate, track, store, process, receive, and transmit electronic data, such as results, actions, determinations, responses, computer code, interactions with interface elements, and/or interactions between user accounts or client devices. For example, the server(s) 106 may receive an indication from the respondent client device(s) 108a-108n or the administrator client device 112 of a user interaction providing input corresponding to a digital survey. In addition, the server(s) 106 can transmit data to the respondent client device(s) 108a-108n or the administrator client device 112. Indeed, the server(s) 106 can communicate with the respondent client device(s) 108a-108n or the administrator client device 112 to send and/or receive data via network 124. In some implementations, the server(s) 106 comprise(s) a distributed server where the server(s) 106 include(s) a number of server devices distributed across the network 124 and located in different physical locations. The server(s) 106 can comprise one or more content servers, application servers, container orchestration servers, communication servers, web-hosting servers, machine-learning servers, and other types of servers.

As also shown in FIG. 1, environment 100 also includes the third-party server(s) 116 that host the third-party large language model(s) 118. In particular, the third-party large language model(s) 118 communicate with the server(s) 106 and/or the database 114 to receive a prompt and generate output from survey response data. For example, the fraudulent response determination system 102 provides a prompt to the third-party large language model(s) 122 that instructs the third-party large language model(s) 122 to identify fraud indicators and/or demographic information from survey response data. In some cases, the third-party machine-learning model(s) 122 refers to various third-party machine-learning models (e.g., ChatGPT, Lambda, Llama, BERT, ROBERTa, Turing-NLG, T5, XLNet). Though not shown, the fraudulent response determination system 102 or the digital survey system 104 can host a large language model (e.g., within or local to the digital survey system or the digital survey system).

As shown in FIG. 1, the server(s) 106 can also include the fraudulent response determination system 102 as part of the digital survey system 104. The digital survey system 104 can communicate with the respondent client device(s) 108a-108n to perform various functions associated with the client application(s) 110a-110n, such as managing accounts, initiating tasks, and/or receiving user preferences. Indeed, digital survey system 104 can manage, store, and maintain user profiles and preferences associated with the respondent client device(s) 108a-108n. In some embodiments, the fraudulent response determination system 102 and/or the digital survey system 104 utilize the database 114 to store and access information pertaining to user profiles, user preferences, topics, or other data related to determining contexts for interactions.

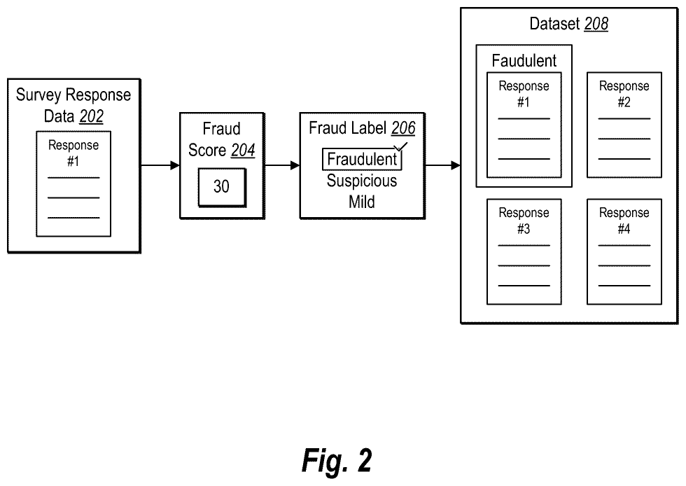

As mentioned, the fraudulent response determination system 102 detects fraudulent response data by generating a fraud score for survey response data of a response of a digital survey. In particular, the fraudulent response determination system 102 utilizes the fraud score to generate a label for the survey response data and then update a dataset of responses associated with responses of a digital survey according to the label. FIG. 2 illustrates an example sequence flow for a fraudulent response determination system generating a fraud score for survey response data and updating a dataset of responses of a digital survey in accordance with one or more embodiments.

As shown in FIG. 2, the fraudulent response determination system 102 receives survey response data 202. Specifically, the fraudulent response determination system 102 receives survey response data 202 associated with a digital survey. For example, survey response data corresponds to a portion of a response to a digital survey that comprises information provided by respondents in response to questions of a digital survey. To illustrate, a response can include digital elements of the digital survey, such as the survey response data and information needed to process the digital survey (e.g., survey identifier, device information, time information). In some embodiments, survey response data refers to data from the response that represents respondent input or information received about during input and from which the fraudulent response determination system 102 can glean information. In one or more embodiments, the fraudulent response determination system 102 receives survey response data from a respondent client device associated with the digital survey.

In addition, in one or more embodiments, the fraudulent response determination system 102 extracts survey response data from the response. In particular, the fraudulent response determination system 102 receives a response to a digital survey and extracts survey response data from the responses. For example, the fraudulent response determination system 102 extracts data by extracting the survey response data from the response to identify whether or not the survey response data is fraudulent. In some cases, the fraudulent response determination system 102 provides the survey response data to a dataset of responses for the digital survey.

In one or more embodiments, in addition to survey response data, the fraudulent response determination system 102 extracts or receives device data of a device associated with a digital survey. Specifically, the fraudulent response determination system 102 can extract or receive device data that provides information about the device. For example, the fraudulent response determination system 102 can receive device data along with a response to a digital survey or can extract device data without receiving a response to a digital survey. To illustrate, device data can include device attributes, such as user agent string, browser type and version, operating system and version, screen resolution, color depth, installed fonts, language settings, time zone, device memory, CPU architecture, API and canvas rendering data, audio context, battery status, network information such as IP address and connection type, media devices like connected cameras and microphones, cookies, local storage, session storage, and touch or mouse interaction patterns.

Further, in addition device data, the fraudulent response determination system 102 can generate a digital fingerprint for a device. Specifically, the fraudulent response determination system 102 generates a digital fingerprint by gathering various data points associated with a device and using the data to create a unique identifier. For example, the fraudulent response determination system 102 can generate a digital fingerprint from web scripting language execution in web pages, analyzing HTTP headers, capturing device and network metadata, monitoring cookies and local storage, using peer-to-peer communication applications for IP and media device details, employing font enumeration, gathering behavioral data like mouse movements and keystrokes, analyzing time zone and system clock information, collecting screen resolution and color depth, detecting browser plugins and extensions, and querying battery status and device sensors.

The fraudulent response determination system 102 can utilize device data and digital fingerprint information along with the survey response data. It is understood that throughout the following description, descriptions relating to utilizing survey response data may also utilize device data and/or digital fingerprint information. These instances include, but are not limited to, survey response data 302, survey response data 402, survey response data 502, survey response data 602, and training survey response data 702.

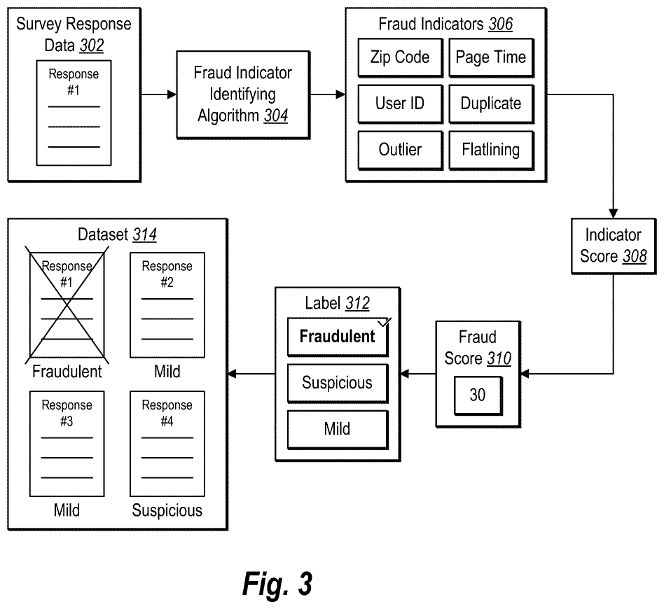

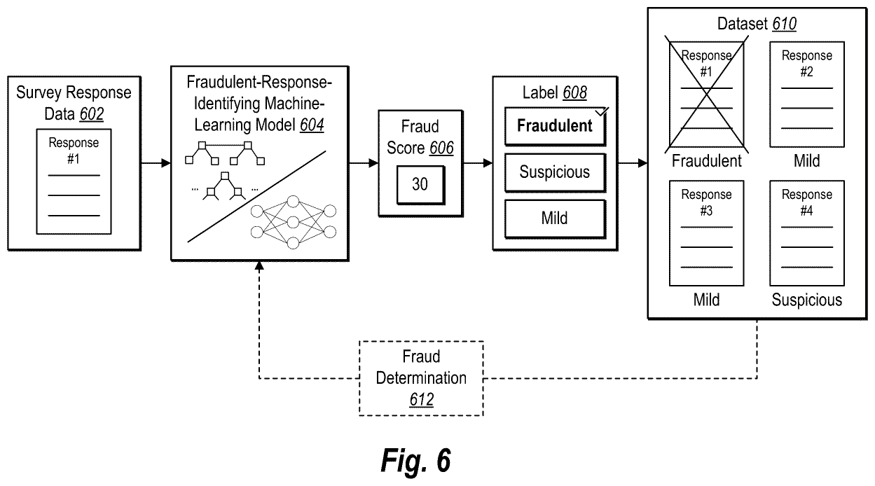

As further shown in FIG. 2, the fraudulent response determination system 102 generates a fraud score 204 for the survey response data. In particular, the fraudulent response determination system 102 generates a fraud score 204 that indicates the likelihood or probability that the survey response data is fraudulent. For example, the fraudulent response determination system 102 can generate fraud score 204 based on data or other information in the survey response data. To illustrate, fraud score 204 by generating a numerical indicator of fraud (e.g., 30). Additional details regarding the fraudulent response determination system 102 generating a fraud score will be provided with respect to FIG. 3 and FIG. 6 below.

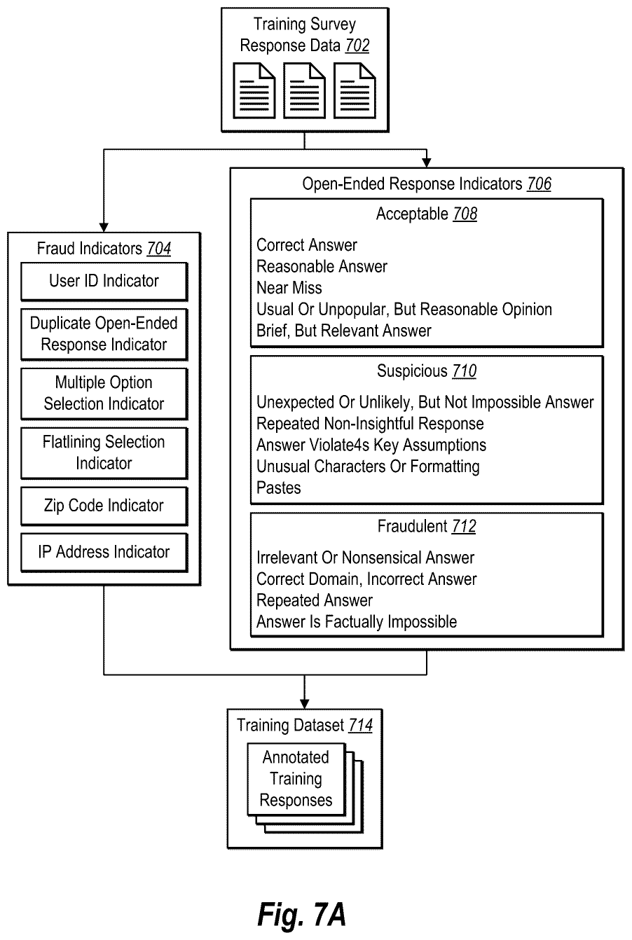

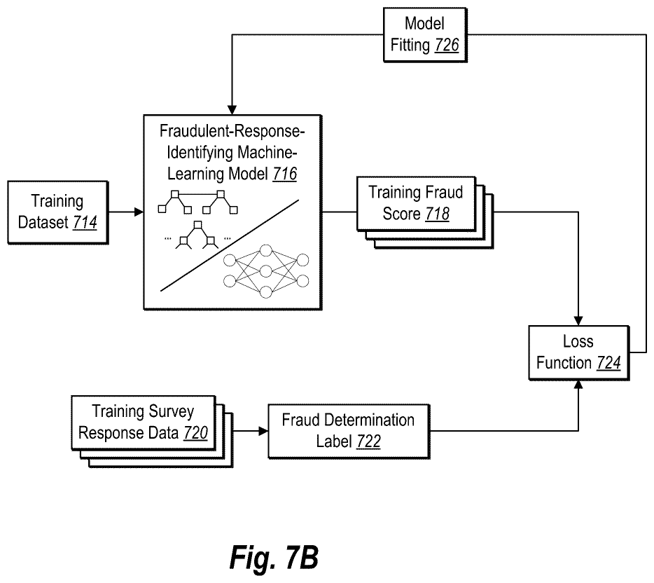

In one or more embodiments, the fraudulent response determination system 102 generates fraud score 204 based on fraud indicators in the survey response data. In particular, the fraudulent response determination system 102 determines fraud indicators by analyzing survey response data to determine or identify data or other information in survey response data that indicates that the survey response data is fraudulent. For example, fraudulent response determination system 102 can identify fraud indicators by identifying indicators associated with user identifications, survey page timers, types of responses, IP addresses, locations, numerical outliers, or repeated text. Additional detail regarding the fraudulent response determination system 102 determining fraud indicators from survey response data is provided below with respect to FIG. 7 below.

In some embodiments, the fraudulent response determination system 102 utilizes a fraud indicator identifying algorithm to determine fraud indicators for survey response data 202. In particular, the fraudulent response determination system 102 utilizes the fraud indicator identifying algorithm to identifying signs, measures, cues, criteria, parameters, or patterns in survey response data that correspond to rules of the fraud indicator identifying algorithm and that indicate that survey response data 202 is fraudulent. Additional detail regarding the fraudulent response determination system 102 utilizing a fraud indicator identifier algorithm is discussed further with respect to FIG. 3 below.

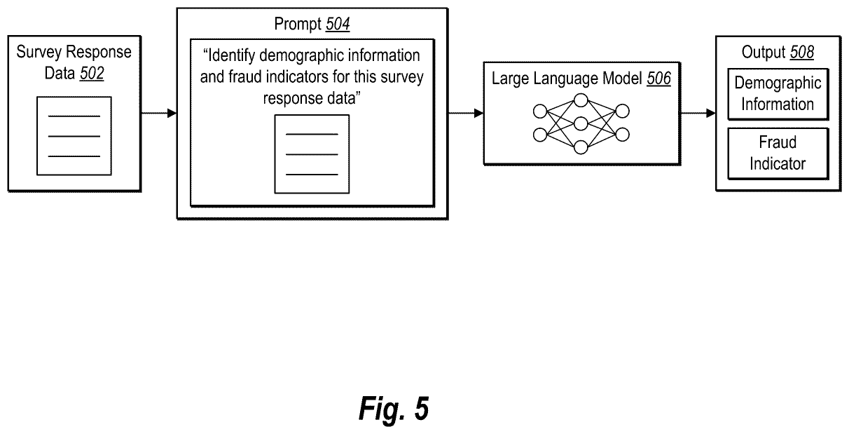

In addition to using a fraud indicator identifying algorithm to identify fraud indicators, fraudulent response determination system 102 can utilize a large language model to generate outputs from survey response data to indicate fraudulent/unusable data or demographic info. For example, the fraudulent response determination system 102 can generate a prompt for a large language model to identify fraud indicators in survey response data and/or to identify demographic information in survey response data. In some cases, the fraudulent response determination system 102 utilizes the fraud indicators and/or demographic information to generate the fraud score for the survey response data (e.g., as part of or in addition to fraud indicators identified by the fraud indicator identification algorithm). Additional detail regarding the fraudulent response determination system 102 generating a prompt for a large language model and utilizing the output from the large language model is discussed with respect to FIG. 5 below.

The fraudulent response determination system 102 may utilize a fraudulent-response-identifying machine-learning model to generate fraud score 204. In particular, the fraudulent response determination system 102 provides survey response data to the trained fraudulent-response-identifying machine-learning model to generate the fraud score 204. For example, the fraudulent-response-identifying machine-learning model that is trained to generate accurate fraud scores from survey response data. Additional details regarding the fraudulent response determination system 102 utilizing a fraudulent-response-identifying machine-learning model to generate a fraud score is provided below with respect to FIG. 6.

In one or more embodiments, the fraudulent response determination system 102 train the fraudulent-response-identifying machine-learning model to generate the accurate fraud scores for survey response data. In particular, the fraudulent response determination system 102 generates a training dataset from annotated survey response data and utilizes the training data set to train the fraudulent response identifying machine-learning model. In some cases, the fraudulent response determination system 102 can also utilize indications of fraud determinations for survey response data to update parameters of the fraudulent-response-identifying machine-learning. Additional details regarding the fraudulent response determination system 102 training and updating the fraudulent-response-identifying machine-learning model are provided below with respect to FIGS. 7A-7B.

As shown, the fraudulent response determination system 102 generates a label 206. Specifically, the fraudulent response determination system 102 utilizes fraud score 204 to generate label 206. For example, the fraudulent response determination system 102 can generate a label 206 by generating a fraudulent label, a suspicious label, or a mild label (or other categories of labels) based on the fraud score. to illustrate, if fraud score is above a certain score, the fraudulent response determination system 102 can determine that fraud score 204 satisfies a threshold for a fraudulent label (e.g., 30), a suspicious label (e.g., 15-30), or a mild label (e.g., below 15). Additional details regarding the fraudulent response determination system 102 generating a label are provided with respect to FIG. 3 and FIG. 6 below.

Further, as shown, the fraudulent response determination system 102 can update dataset 208 based on the label 206. In particular, the fraudulent response determination system 102 updates a dataset of responses for a digital survey based on the label 206. For example, the fraudulent response determination system 102 can determine to perform various different actions based on the label 206. In some embodiments, the fraudulent response determination system 102 can remove the survey response data from dataset 208 in response to generating a fraudulent label. In some cases, after removing the survey response data from dataset 208, the fraudulent response determination system 102 moves the survey response data to another dataset (e.g., to generate a training dataset or to update a machine-learning model). In other cases, the fraudulent response determination system 102 removes the survey response data to a holding area of dataset 208, indicating that the digital survey system 104 should not utilize survey response data from that holding area when analyzing responses.

In one or more embodiments, the fraudulent response determination system 102 updates dataset 208 by associating or identifying the survey response data within dataset 208 based on the label 206. For example, if the fraudulent response determination system 102 the fraudulent response determination system 102 can associate the label with the survey response data in the dataset 208. In some cases, the fraudulent response determination system 102 associates survey response data with certain labels (e.g., suspicious labels or mild labels), while removing survey response data with other labels (e.g., fraudulent labels).

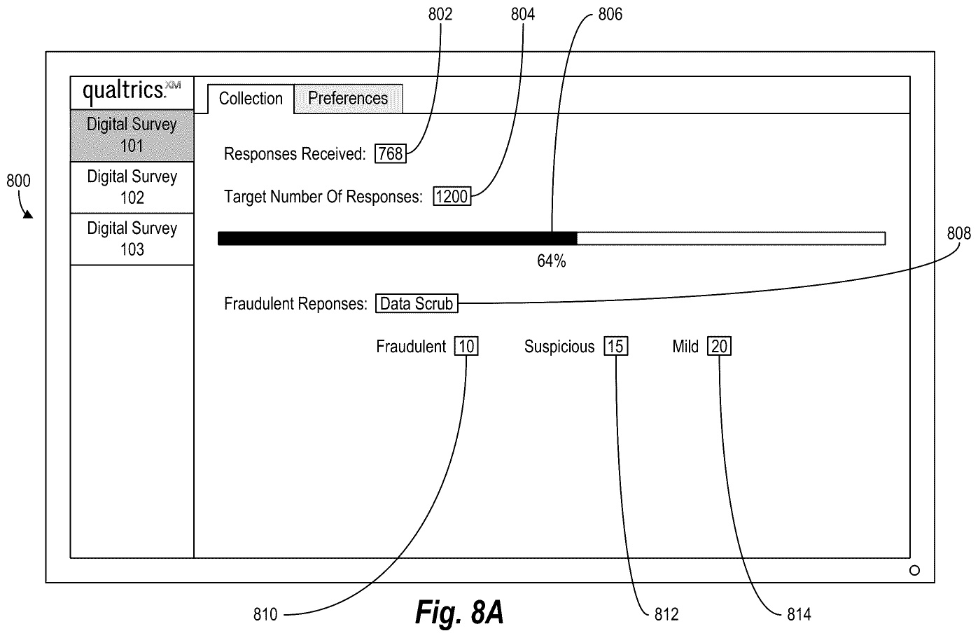

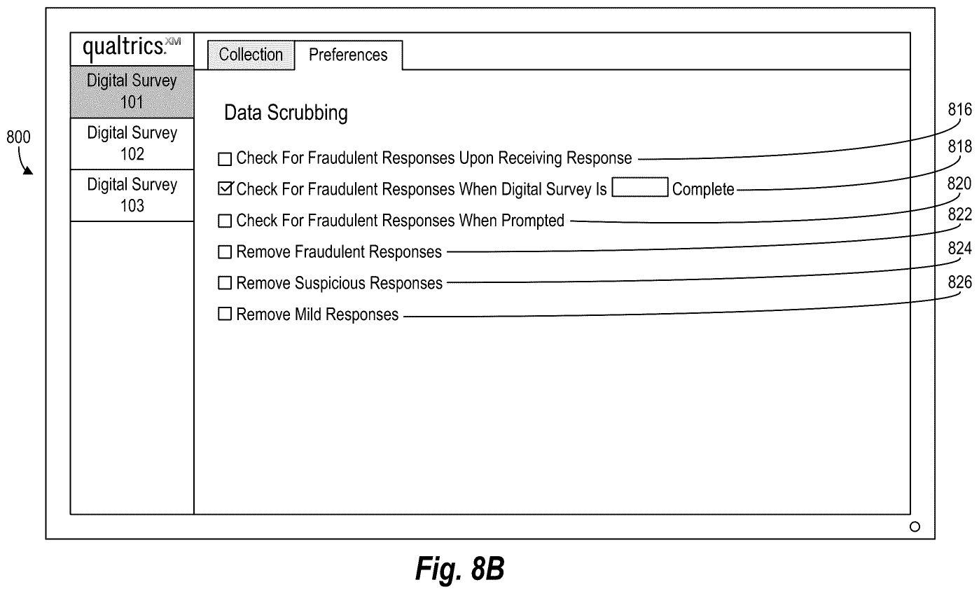

As previously mentioned, in one or more embodiments, the fraudulent response determination system 102 processes survey response data in response to a data scrub request. In particular, the fraudulent response determination system 102 receives a data scrub request from an administrator device that indicates the fraudulent response determination system 102 should determine fraud score 204 for the survey response data. For example, in response to the data scrub request, the fraudulent response determination system 102 can provide survey response data associated with responses of the digital survey to a fraud indicator identifying algorithm to identify fraud indicators and generate a fraud score. As another example, in response to the data scrub request, the fraudulent response determination system 102 can provide survey response data to a fraudulent-response-identifying machine-learning model to generate a fraud score. In some cases, the administrator device provides the data scrub request based on identifying that a digital survey is above a digital survey completion threshold and provides the data scrub request to the fraudulent response determination system 102. Additional detail regarding the fraudulent response determination system 102 receiving a data scrub request is provided with respect to FIGS. 8A-8B below.

As previously mentioned, the fraudulent response determination system 102 determines fraud indicators for survey response data. In particular, the fraudulent response determination system 102 utilizes a fraud indicator identifying algorithm to identify fraud indicators from survey response data and generates a fraud score for the survey response data based on the fraud identifiers. FIG. 3 illustrates an example flowchart for the fraudulent response determination system 102 utilizing a fraud indicator identification algorithm to identify fraud indicators to generate a fraud score and update a dataset of responses of a digital survey in accordance with one or more embodiments.

As shown, the fraudulent response determination system 102 receives survey response data 302. In particular, the fraudulent response determination system 102 receives survey response data from respondent client devices and extracts survey response data as described above in relation to FIG. 2. The fraudulent response determination system 102 provides the survey response data to the fraud indicator identifying algorithm 304. Specifically, fraud indicator identifying algorithm 304 includes a rules-based algorithm that determines fraud indicators by identifying information, features, or data in survey response data that correspond to known identifiers of fraud. For example, the fraud indicator identifying algorithm can be a pattern identifying algorithm that finds patterns in datasets (e.g., an FP-growth algorithm). In one or more embodiments, the fraud indicator identifying algorithm is associated with a dataset of responses for the digital survey and the fraudulent response determination system 102 can send a prompt that instructs the fraud indicator identifying algorithm to identify fraud indicators in survey response data of the digital survey. For example, the fraud indicator identifying algorithm can receive an instruction to access the dataset of responses and identify fraud indicators in the survey response data.

In addition, in one or more embodiments, the fraud indicator identifying algorithm 304 utilizes several algorithms or systems to determine fraud indicators 306. For example, the fraud indicator identifying algorithm 304 utilizes a natural language processing algorithm to identify language in the survey response data in order to identify fraud indicators in the survey response data. In some cases, the natural language processing algorithm is native to the fraud indicator identifying algorithm. In other cases, the natural language processing algorithm is located on a separate third-party system to the fraud indicator identifying algorithm (or fraudulent response determination system 102).

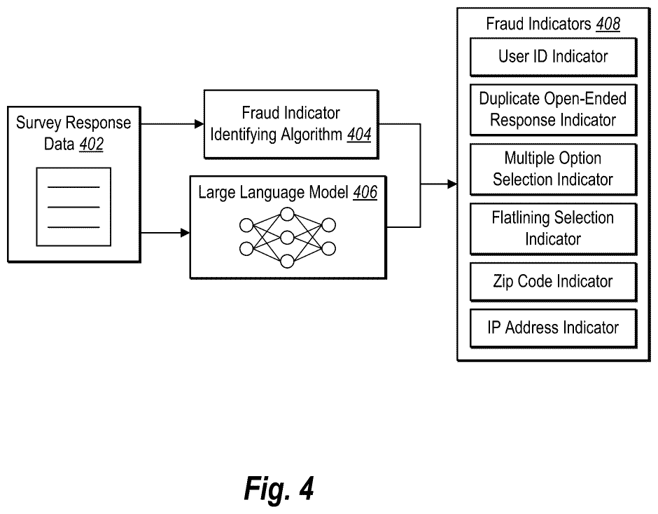

As shown, and as previously mentioned, in one or more embodiments, the fraudulent response determination system 102 utilizes the fraud indicator identifying algorithm 304 to determine fraud indicators 306 for the survey response data. Specifically, the fraud indicator identifying algorithm 304 identifies fraud indicators 306 by identifying known indicators in survey response data (and other device data) that suggest that the survey response data is fraudulent. For example, the fraud indicator identifying algorithm 304 can identify user identification indicators, survey page time indicators, duplicate open-ended response indicators, multiple option selection indicator, flatlining selection indicators, zip code indicators, internet protocol (IP) address indicators, duplicate location indicators, numerical outlier indicators, non-insightful response indicators, repeated text indicators, or country indicators. Additional detail regarding fraud indicators will be provided below with respect to FIG. 4.

As shown, the fraudulent response determination system 102 generates an indicator score 308. In particular, the fraudulent response determination system 102 utilizes the fraud indicator identifying algorithm 304 to generate an indicator score 308 that indicates a score for each of the fraud indicator. For example, the fraud indicator identifying algorithm 304 generates a score for fraud indicators it identifies in the survey response data. In some cases, if the fraud indicator identifying algorithm 304 identifies the fraud indicator, the fraud indicator identifying algorithm 304 gives each instance of the fraud indictor the same indicator score.

In other cases, the fraud indicator identifying algorithm 304 generates an indicator score based on the fraud indicator. Specifically, the fraud indicator identifying algorithm 304 generates different scores based on identifying different levels or intensity of a fraud indicator. For example, in some cases, in response to the fraud indicator identifying algorithm 304 identifying a survey page time indicator, the fraud indicator identifying algorithm 304 may generate a firstscore (e.g., 0) indicating that the timing is acceptable if the survey page timer is within a threshold of the average page speed or a second, higher score (e.g., 30) if the survey page timer is outside of the threshold of average page speed. In other cases, the fraud indicator identifying algorithm 304 utilizes a plurality of thresholds and assigns a first score (e.g., 0) if the survey page timer is below a first threshold, a second score (e.g., 15) if the survey page timer is above the first threshold and below a second threshold, and a third score (e.g., 30) if the survey page timer is above the second threshold.

In addition, in one or more embodiments, the fraudulent response determination system 102 utilizes the fraud indicator identifying algorithm 304 to generate a fraudulent response indicator. In particular, the fraud indicator identifying algorithm 304 generates a fraudulent response indicator in response to generating an indicator score that is high enough to indicate that the response is fraudulent. For example, the fraud indicator identifying algorithm 304 can identify that a survey page time is outside the threshold of average page speed and generate the fraud score to satisfy a fraudulent response threshold indicating that the response is likely fraudulent. To illustrate, if the survey page timer is outside of a threshold of average speed, the fraud indicator identifying algorithm 304 can generate a fraud score of 30, satisfying a threshold that indicates that survey response data with a fraud score of 30 or higher is considered fraudulent.

As shown, and as previously mentioned, the fraudulent response determination system 102 generates a fraud score 310. In particular, the fraudulent response determination system 102 generates the fraud score 310 from a combination of the indicator scores for the fraud indicators 306. For example, the fraudulent response determination system 102 sums up the indicator scores for the fraud indicators to generate the fraud score. As an illustration, the fraud indicator identification algorithm 304 can identify and score three different fraud indicators found in survey response data 302 with an indicator score of 10 each. The fraudulent response determination system 102 can add the separate scores for the three different fraud indicators to obtain a fraud score of 30.

In one or more embodiments, the fraudulent response determination system 102 utilizes a neural network to generate a fraud score. For example, the fraudulent response determination system 102 provides the fraud indicators 306 and/or the indicator score 308 to the neural network and the neural network determines a fraud score 310 for the survey response data 302. In some cases, the neural network is trained to weigh the fraud indicators 306 and/or the indicator score 308 to generate a fraud score 310 for the survey response data 302.

As shown, the fraudulent response determination system 102 generates a label 312 for the survey response data. In particular, the fraudulent response determination system 102 generates the label 312 based on fraud score 310. For example, the fraudulent response determination system 102 can identify that the fraud score satisfies scores for a fraudulent label, a suspicious label, or a mild label (or “acceptable” label). A fraudulent label can indicate that the survey response data is likely fraudulent, a suspicious label indicates that the survey response data may be fraudulent due to the survey response data showing some indicators, and a mild label indicates that the survey response data is not fraudulent. As an illustration, the fraudulent response determination system 102 can generate a fraudulent label if the fraud score is 30 or above, a suspicious label if the fraud score is 15-29, or a mild label if the fraud score is 14 or below.

As further illustrated in FIG. 3, and as described above in relation to FIG. 2, the fraudulent response determination system 102 can update a dataset 314 based on the label. For example, the fraudulent response determination system 102 can remove survey response data from the dataset 314 comprising responses to the digital survey. As also shown, the fraudulent response determination system 102 can label or otherwise identify survey response with the label 312 (e.g., mild or suspicious).

As previously mentioned, the fraudulent response determination system 102 utilizes a fraud indicator identifying algorithm to determine fraud indicators from survey response data. In particular, the fraudulent response determination system 102 utilizes the fraud indicator identifying algorithm to identify fraud indicators in survey response data that indicate that the survey response data may be fraudulent. FIG. 4 illustrates an example diagram for determining one or more fraud indicators from survey response data in accordance with one or more embodiments.

As shown in FIG. 4, the fraudulent response determination system 102 receives survey response data 402 and utilizes the fraud indicator identifying algorithm 404 and/or the large language model 406 to determine fraud indicators 408. In particular, the fraudulent response determination system 102 uses the fraud indicator identifying algorithm to identify some fraud indicators and the large language model 406 to generate other fraud indicators (e.g., by analyzing different types of response data such as structured data or free form text utilizing the different methods). In one or more embodiments, the fraudulent response determination system 102 utilizes the fraud indicators in a similar manner, regardless of whether the fraud indicator is identified by the fraud indicator identifying algorithm 404 or the large language model 406. For example, as mentioned above in connection with FIG. 3, the fraudulent response determination system 102 (or the fraud indicator identifying algorithm) generates an indicator score for each of the fraud indicators in order to generate a fraud score. Indeed, the fraudulent response determination system 102 generates an overall fraud score for survey response data based on the indicator score, regardless of whether the indicator scores are from the large language model or the fraud indicator identifying algorithm.

As just mentioned, the fraudulent response determination system 102 generates the fraud score from the indicator scores. In particular, each fraud indicator has a corresponding indicator score so that, when the fraud indicator identifying algorithm 404 identifies the fraud indicator, the fraud indicator identifying algorithm 404 applies the score to the fraud indicator. For example, the fraudulent response determination system 102 may identify that there is a suspicious instance of a fraud indicator and generate a lower indicator score or may identify that there is a fraudulent instance of a fraud indicator and generate a higher indicator score.

As shown, fraud indicators 408 can include a user identification (ID) indicator. In particular, the fraudulent response determination system 102 can determine a user identification indicator by determining that the user identification was previously used in a response for the digital survey. For example, the fraudulent response determination system 102 can utilize a completely automated public Turing test to tell computers and humas apart (CAPTCHA) for logins with a user identification and determine that a CAPTCHA score for the user identification indicates that the user identification is being used by a bot (e.g., the CAPTCHA score satisfies a bot threshold). Moreover, in some cases, the system can also identify that the user identification was previously used by a bot and so, the next time a respondent utilizes that that user identification, the fraudulent response determination system 102 generates the user identification indicator based on the previous fraud.

In addition, the fraudulent response determination system 102 determines a user identification indicator by identifying that the user identification was previously used to submit another response for the digital survey. In some cases, the fraudulent response determination system 102 identifies that there is one other instance of survey response data for the user ID (e.g., respondent accidentally responded to survey twice), while in other cases there may be several survey response data instances with the same user identification. Moreover, the fraudulent response determination system 102 may determine a user identification indicator by identifying that the user identification was previously associated with fraud. For example, the fraudulent response determination system 102 may determine that the user identification was previously associated with survey response data that the fraudulent response determination system 102 identified as fraudulent in connection with a different survey, though this may be the first time they are submitting a response in another survey.

If the fraud indicator identifying algorithm determines that the survey response data comprises user identification indicators, the fraudulent response determination system 102 can generate a user identification indicator score. For example, the fraudulent response determination system 102 scores survey response data with a user identification score based on the user identification indicators identified in the survey response data. As an illustration, if the fraudulent response determination system 102 identifies that a CAPTCHA score indicates that the user identification may be used is a bot, the fraudulent response determination system 102 gives the survey response data a score of 15. In some cases, the fraudulent response determination system 102 generates an indicator score for each instance of identifying a user identification indicator, such as by applying 15 points for each user identification indicator identified.

As also shown, the fraudulent response determination system 102 can also generate a duplicate open-ended response indicator. In particular, the fraudulent response determination system 102 generates a duplicate open-ended response indicator when the fraudulent response determination system 102 identifies that the text from an open-ended survey question matches (e.g., is identical to) open-ended responses in multiple questions. In some instances, multiple survey questions may have similar or reasonable answers for multiple questions, and in these instances, the fraudulent response determination system 102 generates a lower indicator score (e.g., 15). However, when the exact same response or phrase is used in multiple questions where it is not reasonable, the fraudulent response determination system 102 generates a higher indicator score (e.g., 30).

In addition, as shown, the fraudulent response determination system 102 can generate a multiple option selection indicator. Specifically, the fraudulent response determination system 102 can generate a multiple option selection indicator by identifying that on at least a threshold number (e.g., 2) of questions with at least a threshold number (e.g., 4) of sub-questions the respondent selected a certain percent (e.g., 80%) or more of the options and the percentage of selected options was at least a threshold number (e.g., 2.85) of standard deviations higher than the population average for the survey. The fraudulent response determination system 102 can determine an indicator score based on the number of questions for which the respondent selected multiple options. For example, if the fraud indicator identifying algorithm determines that 2 questions that satisfy a multiple option selection indicator, the fraudulent response determination system 102 generates a lower score (e.g., 10). However, if the fraudulent response determination system 102 determines that three or more questions satisfy the multiple option selection indicator, the fraudulent response determination system 102 generates a higher score (e.g., 15).

Further, as shown, the fraudulent response determination system 102 can also determine a flatlining selection indicator. In particular, the fraudulent response determination system 102 determines a flatlining selection indicator for respondents to a digital survey with at least a threshold number (e.g., 6) of sub-questions with at least a threshold number (e.g., 3) of columns and provided the same answer to all questions, or all questions but one. The fraudulent response determination system 102 may also generate varying levels of flatlining selections with corresponding indicator scores based on a survey page timer speed associated with the flatlining selection. For example, the fraudulent response determination system 102 may generate suspicious flatlining indicators based on flatlining answers that are a threshold number of standard deviations higher than the population but where the survey page time indicates there was no speeding. In these cases, the fraudulent response determination system 102 can generate a score based on the instances of suspicious flatlining (e.g., 5 points for 1, 10 points for 2, and 15 points for 3 or more instances). As an example, the fraudulent response determination system 102 can identify fraudulent flatlining indicators based on flatlining answers that are at least a threshold number (e.g., 1.85) of standard deviations higher than the population and where survey page time indicates that there was speeding. In these cases, the fraudulent response determination system 102 can generate a score based on the instances of fraudulent flatlining (e.g., 10 points for 1, 15 points for 2, and 15 points for 3 or more instances).

As also shown, the fraudulent response determination system 102 can generate a zip code indicator. Specifically, the fraudulent response determination system 102 generates a zip code indicator by identifying zip codes in the survey response data that have more responses than the average per zip code by a threshold statistical value (e.g., 4 standard deviations) and responses from the zip code comprise a threshold percentage (e.g., 0.5%) of the total survey response count. In additional embodiments, if the zip code has more responses than the average zip code by more than the threshold statistical value, the fraudulent response determination system 102 marks the zip code as suspicious. In some case, the fraudulent response determination system 102 utilizes the large language model 406 to determine the suspicious zip codes in survey response data. In survey response data where the fraudulent response determination system 102 determines that there is a zip code indicator, the fraudulent response determination system 102 generates an indicator score (e.g., 30) for each instance survey response data.

In addition, as shown, the fraudulent response determination system 102 can also generate an internet protocol (IP) address indicator. In particular, the fraudulent response determination system 102 can determine that an IP address that has more responses by a threshold number (e.g., 3) of standard deviations than the average IP address for the digital survey and the IP address has more than a threshold number (e.g., 5) of responses for the digital survey, then the fraudulent response determination system 102 generates the IP address indicator. Further, if the fraudulent response determination system 102 determines an IP address indicator, the fraudulent response determination system 102 generates an IP address indicator score for each instance (e.g., 30).

Though not shown, the fraudulent response determination system 102 can also generate additional fraud indicators. For example, the fraudulent response determination system 102 can generate a survey page time indicator. Specifically, the fraudulent response determination system 102 can receive indications of an amount of time that a respondent (or alleged respondent) spent on each page of a survey and based on average page time for the digital survey, generate a survey page time indicator. For example, if the survey page time for the survey is lower than average, the fraudulent response determination system 102 can generate a survey page time indicator. Moreover, the fraudulent response determination system 102 can generate an indicator score based on the average page time. For example, if it is slightly higher than usual page time indicators, the fraudulent response determination system 102 may generate a lower indicator score (e.g., 15) but if it is above a threshold amount higher, the fraudulent response determination system 102 may generate a higher indicator score (e.g., 30).

In addition, the fraudulent response determination system 102 can determine a paradata indicator. In particular, the fraudulent response determination system 102 receives indications of paradata corresponding to the interactions or movements of respondent (or alleged respondent) interactions with a client device while responding to the digital survey. For example, the fraudulent response determination system 102 receives indication of keystrokes, mouse clicks, clickstream data (e.g., the sequence of clicks while navigating through a digital survey), scroll depth, hover data, touch data, form interaction data, voice interaction data, eye tracking data, network and connectivity data, or acceleration data. To illustrate, the fraudulent response determination system 102 can utilize paradata indicators that indicate that a respondent is fraudulently answering digital survey questions.

Further, the fraudulent response determination system 102 can determine a duplicate location and variables indicator. For example, the fraudulent response determination system 102 can determine a duplicate location and variables indicator if a threshold number (e.g., 5) of conditions are met. First, for example, the fraudulent response determination system 102 determines whether the digital survey has at least a first number (e.g., 5) of demographic questions and IP address information, upon which up to a second number (e.g., 8) of demographic variables need to be identified by large language model 406. Second, if any demographic information generated by the large language model does not vary between responses, the fraudulent response determination system 102 generates a duplicate location and variable indicator. Third, if the fraudulent response determination system 102 determines that multiple responses have duplicate IP addresses and all the demographics match, all of the selected options match, and if there are missing values they have the same missing value in the same variable. Fourth, the total number of identified duplicates in the survey amounts to less than a threshold percent (e.g., 20%) of the total number of responses for the digital survey. Fifth, for all responses for the digital survey, the fraudulent response determination system 102 determines that there are not more than a threshold number (e.g., 3) clusters of duplicate responses one hundred or more answers each. When all the conditions are satisfied, the fraudulent response determination system 102 can generate an indicator score (e.g., 30) for each response. However, if the fourth or fifth conditions are not met, the fraudulent response determination system 102 flags the survey response data but does not generate an indicator score. Further, if the conditions do not warrant full removal, the fraudulent response determination system 102 does not score the first set of survey response data (e.g., assigns the first set of survey response data an indicator score of 0) and assigns subsequent instances of survey response data an indicator score that satisfy the requirements an indicator score (e.g., 30)

Moreover, the fraudulent response determination system 102 can determine a numerical outlier indicator. Specifically, the fraudulent response determination system 102 can determine a numerical outlier indicator by identifying survey response data that are a threshold statistical value (e.g., 3 or more standard deviations) away from the mean of the survey. An indicator score for a numerical outlier indicator is based on the number of questions flagged with the numerical outlier. For example, if the fraudulent response determination system 102 generates a score for each question flagged (e.g., 2 points), with a max score for 6 questions determined as outliers (e.g., 12 points). In some cases, the fraudulent response determination system 102 determines a multivariate numerical outlier indicator by performing multivariate outlier analysis to analyze the pattern of responses across questions of a digital survey and identify survey response data that differ significantly from the majority of survey response data. For example, the fraudulent response determination system 102 can identify survey response data as an outlier if the combination of responses survey response data does not align with a general pattern observed in other survey response data of the digital survey.

In addition, the fraudulent response determination system 102 can determine large language model-based fraud indicators. In particular, the fraudulent response determination system 102 can instruct a large language model to identify fraud indicators in text of open-ended responses for the survey response data and generate an indicator score based on the fraud indicators identified by the large language model. For example, if there are not survey page time indicators or a paste indicator (e.g., that the respondent pastes information into the open-ended question) for the survey response data, then the fraudulent response determination system 102 assigns each question that the large language model flags as suspicious a lower indicator score (e.g., 10) and assigns each question that the large language model flags as fraudulent a higher indicator score (e.g., 30). In addition, for example, if there are survey page timer indicators or paste indicators, then the fraudulent response determination system 102 assigns each suspicious and fraudulent large language model-based indicators a higher indicator score (e.g., 25 for suspicious and 35 for fraudulent) than those without survey page timer indicators or paste indicators. However, in some embodiments, large language model-based indicators can only result in a max number of points (e.g., 70). Additional detail regarding large language model-based fraud indicators will be provided below with respect to FIG. 5.

Also, the fraudulent response determination system 102 can determine multiple non-insightful response indicators. Specifically, the fraudulent response determination system 102 determines that survey response data has a suspicious multiple non-insightful response indicator if there are 3 or more non-insightful responses but on less than all of the answered open-ended questions. In some embodiments, the fraudulent response determination system 102 determines that survey response data has a fraudulent multiple non-insightful response indicator if the survey response data has 3 or more (or other number) non-insightful responses and those 3 responses constitute all the of the open-ended responses for the digital survey, or if the survey response data has 5 or more (or other number) non-insightful responses (even if not all the open-ended responses). In cases where the fraudulent response determination system 102 determines a suspicious multiple non-insightful response indicator, the fraudulent response determination system 102 will generate a lower indicator score (e.g., 10 points), and will generate a higher indicator score for a fraudulent multiple non-insightful response indicator (e.g., 20 points).

Moreover, the fraudulent response determination system 102 can determine a repeated text indicator. Specifically, the fraudulent response determination system 102 can determine a repeated text indicator by determining that the survey response data has repeated text in 3 or more questions. However, if the questions were already determined to be multiple non-insightful responses, the fraudulent response determination system 102 should not determine them to be repeated text indicators (e.g., either will be multiple non-insightful or repeated text, not both). In cases where the fraudulent response determination system 102 determines that the survey response data comprises a suspicious repeated text indicator, the fraudulent response determination system 102 will generate lower indicator score (e.g., 15 points). In instances where the fraudulent response determination system 102 determines that survey response data comprises a fraudulent repeated text indicator, the fraudulent response determination system 102 will generate a higher indicator score (e.g., 25 points).

Lastly, the fraudulent response determination system 102 can determine a location outside country indicator. In particular, the fraudulent response determination system 102 can determine that the location of the survey response data is outside the target country (or countries). If the fraudulent response determination system 102 determines the location outside country indicator, the fraudulent response determination system 102 will generate an indicator score for the survey response data (e.g., 30 points).

As previously mentioned, the fraudulent response determination system 102 utilizes a large language model to identify fraud indicators and demographic information for survey response data. Specifically, the fraudulent response determination system 102 generates a prompt comprising survey response data for the large language model to generate an output of fraud indicators and demographic information based on the survey response data. FIG. 5 illustrates an example diagram for generating a prompt to generate an output based on survey response data and providing the prompt to a large language model to generate the output in accordance with one or more embodiments.

As shown in FIG. 5, the fraudulent response determination system 102 utilizes survey response data 502 to generate prompt 504. In particular, prompt 504 can comprise a textual prompt that comprises an instruction for the large language model to generate a specific output. For example, prompt 504 can comprise an instruction for the large language model to identify information in the survey response data and generate an output comprising the information. As shown, prompt 504 comprises an instruction for a large language model to “identify demographic information and fraud indicators for this survey response data.” Additionally, in various embodiments, the prompt 504 includes natural language text and/or structured text.

As also shown in FIG. 5, the fraudulent response determination system 102 provides prompt 504 to large language model 506 to generate output 508. In particular, the fraudulent response determination system 102 provides prompt 504 to large language model 506 to generate the output 508 as directed in prompt 504. For example, the fraudulent response determination system 102 can utilize the large language model to identify demographic information for survey response data.

In one or more embodiments, the fraudulent response determination system 102 utilizes large language model 506 to identify demographic information for survey response data by identifying various information that relates to the demographics of the respondent, or the respondent client device associated with the survey response data. For example, the large language model can generate an output with the demographic information identified from the survey response data. To illustrate, the fraudulent response determination system 102 can utilize the large language model to determine demographic information such as zip code, IP address, age, gender, income, education level, occupation, marital status, ethnicity, and geographic location.

In addition, in one or more embodiments, the fraudulent response determination system 102 can utilize large language model 506 to generate output of fraud indicators for survey response data. In particular, the fraudulent response determination system 102 can utilize the large language model to generate large language model-based fraud indicators for text of open-ended response questions. For example, the fraudulent response determination system 102 can utilize a large language model to determine fraud in open-ended response questions by instructing the large language model to identify answers that are factually impossible, highly improbable, or have a high level of inconsistency. To illustrate, if the demographic information for the survey response data indicates that the respondent is fifty years old, but an open-ended response indicates that the respondent is only twenty years and it is factually impossible to be multiple ages at the same time, large language model 506 determines is fraud indicator. As another illustration, if survey response data indicates that a respondent is 18 but on a question about employment, the respondent indicates that they are retired, where it is highly unlikely that someone is both 18 and retired, large language model 506 determines a fraud indicator. Indeed, large language model 506 can identify instances where, due to inconsistencies, it is more likely that the response is fraudulent than the response is factually possible and mark those as fraud indicators.

In addition, the fraudulent response determination system 102 can generate a prompt that instructs the large language model to compare survey responses for multiple response for the digital survey. In particular, the fraudulent response determination system 102 can instruct the large language model to compare the survey response data for the multiple responses and generate an output that indicates fraudulent (or potentially fraudulent) survey response data. For example, large language model can indicate the reasons why survey response data is fraudulent (e.g., factually impossible, highlight improbable) along with the indications of the survey response data.

Moreover, large language model 506 can also distinguish between slight inconsistency and egregious or repeated inconsistencies. Specifically, large language model 506 can distinguish between a slight inconsistency where someone misread a question and larger inconsistencies due to speeding through responses, bot generated responses, or other issues. For example, the large language model 506 can provide indications of slight inconsistencies or large inconsistencies in the survey response data.

As previously mentioned, the fraudulent response determination system 102 can utilize a fraudulent-response-identifying machine-learning model to generate a fraud score for survey response data. In particular, the fraudulent response determination system 102 utilizes a fraudulent-response-identifying machine-learning model that generates accurate fraud scores and utilizes the fraud score to generate a label and update a dataset of responses of the digital survey. FIG. 6 illustrates an example diagram for utilizing a fraudulent-response-identifying machine-learning model to generate a fraud score and update a dataset of responses of a digital survey in accordance with one or more embodiments.

As shown, the fraudulent response determination system 102 provides survey response data 602 to fraudulent-response-identifying machine-learning model 604. In particular, fraudulent-response-identifying machine-learning model is trained to generate accurate fraud scores from survey response data. For example, the fraudulent-response-identifying machine-learning model is trained on annotated survey response data to generate fraud scores within a threshold of loss. Additional detail regarding the fraudulent response determination system 102 generating a training dataset and training the fraudulent-response-identifying machine-learning model is provided below with respect to FIGS. 7A-7B.

In one or more embodiments, the fraudulent-response-identifying machine-learning model is a neural network. In particular, the fraudulent-response-identifying machine-learning model is a neural network architecture that combines gated recurrent unit (GRU) layers with an attention mechanism. For example, the GRU layers can efficiently manage the intake of information into the fraudulent-response-identifying machine-learning model, such as by utilizing natural language processing of the survey response data. The attention mechanism can then process the survey response data by concentrating on determining portions of the survey response data that indicate the survey response data is fraudulent.

In addition to the GRU layer and the attention layer, the fraudulent response determination system 102 can generate a response-level embedding comprising metadata from responses to the digital survey and a survey-level embedding comprising metadata from the digital survey. The fraudulent-response-identifying machine-learning model or the fraudulent response determination system 102 can then concatenate the output of the fraudulent-response identifying machine-learning model with the response-level embedding and the survey-level embedding and provide the concatenated materials to a dense layer, to then provide the final output of a fraud score for the survey response data.

As shown, the fraudulent response determination system 102 utilizes fraudulent-response-identifying machine-learning model 604 to generate fraud score 606. In particular, the fraudulent-response-identifying machine-learning model 604 generates fraud score 606 that indicates a probability that survey response data 602 is fraudulent. For example, the fraud score can be a numerical indicator (e.g., 30), a binary selection option, or an indication of the fraud (e.g., fraudulent, suspicious, mild).

As further shown in FIG. 6, the fraudulent response determination system 102 can generate a label 608 based on fraud score 606. Specifically, the fraudulent response determination system 102 can determine that the fraud score corresponds to a label based on the fraud score satisfying a fraudulent label, a suspicious label, or a mild label. For example, in instances where the fraud score is a numerical indicator, the fraudulent response determination system 102 generates label 608 by generating a fraudulent label when the fraud score is 30 or above, a suspicious label if the fraud score is 15-29, or a mild label if the fraud score is 14 or below. As another example, in cases where the fraud score is a binary selection option, the fraudulent response determination system 102 generates label 608 by generating a fraudulent label if the binary selection option indicates that it is fraudulent or a non-fraudulent label if the binary selection option indicates it is not fraudulent. In addition, as a further example, the fraudulent response determination system 102 generates label 608 by generating a fraudulent label based on a fraudulent indication, a suspicious label based on a suspicious indication, or a mild label based on a mild indication.

As also shown in FIG. 6, the fraudulent response determination system 102 utilizes label 608 to update dataset 610 of responses of the digital survey. In particular, the fraudulent response determination system 102 can update the responses by removing survey response data from dataset 610 based on label 608. For example, if the label 608 indicates that the survey response data is fraudulent, then the fraudulent response determination system 102 will remove the survey response data from dataset 610. In addition, if the survey response data has a label other than fraudulent (e.g., suspicious or mild), the fraudulent response determination system 102 can associate the label with the survey response data in dataset 610.

As also shown, the fraudulent response determination system 102 can optionally receive a fraud determination 612. In particular, the fraudulent response determination system 102 can receive fraud determination 612 that indicates that the survey response data was or was not fraudulent and can use fraud determination 612 to update parameters of the fraudulent-response-identifying machine-learning model 604. For example, the fraudulent response determination system 102 can receive a fraud determination 612 from an administrator device of the digital survey that indicates that the survey response data is fraudulent. Additional detail regarding the fraudulent response determination system 102 utilizing a fraud determination to update parameters of the fraudulent-response-identifying machine-learning model provided below with respect to FIG. 7B below.

As previously mentioned, the fraudulent response determination system 102 can generate a training dataset and utilizes the training dataset to train the fraudulent-response-identifying machine-learning model. In particular, the fraudulent response determination system 102 generates a training dataset by annotating survey response data with labels indicating fraudulent survey response data. FIGS. 7A-7B illustrate an example diagram for generating a training dataset and utilizing the training dataset to train a fraudulent-response-identifying machine-learning model in accordance with one or more embodiments. Specifically, FIG. 7A illustrates an example diagram for annotating survey response data to generate a training dataset and FIG. 7B illustrates an example diagram for utilizing the training dataset to train the fraudulent-response-identifying machine-learning model with a loss function.

As shown in FIG. 7A, the fraudulent response determination system 102 receives training survey response data 702. Specifically, training survey response data can comprise various responses to digital surveys that the fraudulent response determination system 102 annotates to train the fraudulent-response-identifying machine-learning model. For example, the training survey response data 702 is survey response data from previously conducted digital surveys. As another example, training survey response data 702 is generated survey response data, e.g., from a large language model or human-drafted survey response data. As a further example, training survey response data is an open-source dataset used to train machine-learning models.

As further shown in FIG. 7A, the fraudulent response determination system 102 annotates training survey response data 702 with fraud indicators 704 and open-ended response indicators 706. In particular, the fraudulent response determination system 102 utilizes a trained team of annotators to annotate training survey response data 702 to generate the training dataset 714. For example, the trained team of annotators identify fraud indicators 704 and open-ended response indicators 706 in the training survey response data and annotate the survey response data by affixing a label or other identifier that the fraudulent-response-identifying machine-learning model can identify and learn from.

As mentioned, the fraudulent response determination system 102 annotates survey response data with fraud indicators 704. In particular, the fraudulent response determination system 102 annotates training survey response data 702 by annotating training response data with fraud indicators 704 as described above with connection to FIG. 4. For example, as described above, the fraudulent response determination system 102 can annotate fraud indicators by annotating user identification indicators, duplicate open-ended response indicators, multiple option selection indicators, flatlining selection indicators, zip code indicators, internet protocol address indicators, survey page time indicators, duplicate location and variables indicators, numerical outlier indicators, multiple non-insightful response indicators, repeated text indicators, and location outside country indicators.

As shown, the fraudulent response determination system 102 also annotates open-ended responses in the training survey response data 702 with open-ended response indicators 706. In particular, the fraudulent response determination system 102 annotates open-ended responses comprising an answer format in a digital survey that allows respondents to provide their thoughts, opinions, or feedback in their own words, without being limited to predefined options. For example, an open-ended question can pose a question and elicit feedback based on the question.

As illustrated, the fraudulent response determination system 102 annotates training survey response data with open-ended response indicators by indicating acceptable open-ended indicators 708, suspicious open-ended indicators 710, and fraudulent open-ended indicators 712. In one or more embodiments, as shown, the fraudulent response determination system 102 annotates training survey response data 702 with non-fraudulent indicators by annotating correct answer indicators. In particular, the fraudulent response determination system 102 annotates correct answers that indicate the survey response data is in the correct domain and the answer is correct. For example, the fraudulent response determination system 102 can annotate training survey response data that describes a negative clinic experience due to long wait time as a non-fraudulent indicator.

As also shown, the fraudulent response determination system 102 can annotate training survey response data with acceptable open-ended indicators 708 by annotating reasonable answer indicators. In particular, the fraudulent response determination system 102 can annotate any reasonable answer to the question that was asked with a non-fraudulent open=ended indicator. In addition, in one or more embodiments, the fraudulent response determination system 102 can annotate training survey response data with acceptable open-ended indicators 708 by annotating near miss indicators. Specifically, the fraudulent response determination system 102 can annotate near misses by annotating a response that is in the correct domain and the answer is close to being right but is still incorrect. For example, the fraudulent response determination system 102 can annotate a near miss indicator when the answer is “21” to “what is 15+7?”

In addition, the fraudulent response determination system 102 can annotate training survey response data with acceptable open-ended indicators 708 by annotating unusual opinion indicators. Specifically, the fraudulent response determination system 102 can annotate unusual opinion indicators by annotating unusual or unpopular but reasonable opinions. For example, the fraudulent response determination system 102 can annotate an unusual opinion when someone answers “potato and bean salad” when asked their favorite way to eat potatoes.

Moreover, the fraudulent response determination system 102 can annotate training survey response data with acceptable open-ended indicators 708 by annotating mild profanity indicators. Specifically, the fraudulent response determination system 102 can annotate mild profanity indicators when survey response data comprises some profanity but answers the question. For example, the fraudulent response determination system 102 can annotate a mild profanity indicator for an answer that includes a particular word typically viewed as mildly profane when asked why they are unlikely to purchase Brand X soda again.

Also, the fraudulent response determination system 102 can annotate training survey response data with acceptable open-ended indicators 708 by annotating brief answer indicators. In particular, the fraudulent response determination system 102 annotates brief answer indicators when the answer is brief, but relevant, such as when the survey response data comprises only a word or phrase but directly answers the question. For example, the fraudulent response determination system 102 can annotate a brief answer indicator for survey response data that comprises the answer “taste” when asked why they prefer a first brand over a second brand or answering “great service” when asked why they are very satisfied with their phone company.

Further, the fraudulent response determination system 102 can annotate training survey response data with acceptable open-ended indicators 708 by annotating partial answer indicators. Specifically, the fraudulent response determination system 102 can annotate partial answer indicators by annotating survey response data that partially answers the question. For example, the fraudulent response determination system 102 can annotate a partial answer indicator for survey response data that provides only a flavor (e.g., banana cream) when asked “what is your favorite ice cream flavor and why?”

Additionally, the fraudulent response determination system 102 can annotate training survey response data with acceptable open-ended indicators 708 by annotating grammar error indicators. In particular, the fraudulent response determination system 102 annotates grammar error indicators by annotating survey response data where the survey response data comprises a reasonable answer, but the survey response data includes spelling errors, typos, abbreviations, or common shorthand (e.g., luv ur stuff).

Moreover, the fraudulent response determination system 102 can annotate training survey response data with acceptable open-ended indicators 708 by annotating a nothing indicator. In particular, the fraudulent response determination system 102 annotates survey response data that comprises the answer “none,” “nothing,” or “no comment” if the answer is reasonable given the question, such as when the question asks for improvements or suggestions, and the respondent does not have any. For example, acceptable answers in such questions would include “none,” “nothing,” “everything is great,” “can't think of any,” “it has everything I need,” “it is a great product,” I'm happy with it,” or “N/A.”

As also illustrated in FIG. 7A, the fraudulent response determination system 102 can annotate training survey response data with suspicious open-ended indicators 710. As shown, the fraudulent response determination system 102 can annotate training survey response data with suspicious open-ended indicators 710 by annotating extremely unusual indicators. Specifically, the fraudulent response determination system 102 annotates extremely unusual indicators by annotating answers where the response is unlikely or unexpected given the question, particularly when compared to answers provided by other respondents. For example, an extremely unusual answer could include saying “burger” when asked about favorite food from an Italian menu, especially when no one else mentions any other types of non-Italian food.

In addition, the fraudulent response determination system 102 can annotate training survey response data with suspicious open-ended indicators 710 by annotating repeated non-insightful indicators. In particular, the fraudulent response determination system 102 can annotate repeated non-insightful indicators when the survey response data comprises non-insightful responses to 3 or more open-ended questions for which it is reasonable to have an opinion. For example, repeated non-insightful responses can include low effort responses that convey no opinion in the topic being asked about the survey question, such as “I don't know,” “Idk,” “not sure,” “no comment,” among others.

Also, the fraudulent response determination system 102 can annotate training survey response data with suspicious open-ended indicators 710 by annotating key assumption violation indicators. Specifically, the fraudulent response determination system 102 can annotate key assumption violation indicators when the survey response data violates a key assumption. For example, the fraudulent response determination system 102 can annotate survey response data that indicates the respondent is not a teacher when asked would they love about being a teacher.

Moreover, the fraudulent response determination system 102 can annotate training survey response data with suspicious open-ended indicators 710 by annotating unusual character indicators. Specifically, the fraudulent response determination system 102 can annotate unusual character indicators by annotating survey response data that contains unusual or nonsensical characters, excessive punctuation, or strange formatting, as could be indicative of bot activity or non-serious responses, especially if the response does not answer the question. However, the fraudulent response determination system 102 may not annotate survey response data with all capital letters (e.g., this is an acceptable answer).

Further, the fraudulent response determination system 102 can annotate training survey response data with suspicious open-ended indicators 710 by annotating pasted indicators. Specifically, the fraudulent response determination system 102 can annotate a pasted indicator when responses have been pasted in the digital survey (e.g., instead of typed in the digital survey).

Additionally, the fraudulent response determination system 102 can annotate training survey response data with suspicious open-ended indicators 710 by annotating suspicious language indicators. Specifically, the fraudulent response determination system 102 annotates a suspicious language indicator if the language of the survey response data is suspicious due to being overly vague, incomplete, or in an unusual format, though there is not enough information to classify the language as fraudulent.

As previously mentioned, the fraudulent response determination system 102 can annotate training survey response data with fraudulent open-ended indicators. In some cases, the fraudulent response determination system 102 can annotate training survey response data with suspicious open-ended indicators 710 by annotating irrelevant answer indicators. Specifically, the fraudulent response determination system 102 annotates an irrelevant answer indicator if the survey response data has no connection to the question's domain or is nonsensical. For example, the fraudulent response determination system 102 annotates an irrelevant answer indicator when the survey response data comprises “butter” to a question about a visit to a clinic or answering “Mr. Bean” to a question about the first president of the United States. As another example, the fraudulent response determination system 102 annotates an irrelevant answer when the answer is non-sensical and from which there is little meaning, such as “I am want butterfly should make me happy.”

In addition, the fraudulent response determination system 102 can annotate training survey response data with suspicious open-ended indicators 710 by annotating correct domain/incorrect answer indicators. Specifically, the fraudulent response determination system 102 annotates a correct domain/incorrect answer indicator when the survey response data is in the correct domain, but the answer is wrong in a way that suggests the respondent did not try or does not know what they are saying. For example, the fraudulent response determination system 102 should annotate a correct domain/incorrect answer for survey response data that comprises “Andrew Jackson” to a question about the first president of the United States.

Moreover, the fraudulent response determination system 102 can annotate training survey response data with suspicious open-ended indicators 710 by annotating repeated answer indicators. In particular, the fraudulent response determination system 102 annotates repeated answer indicators by annotating where the survey response data comprises the same answer for multiple questions that would not be expected to have the same answer. However, the fraudulent response determination system 102 should not annotate repeated answers (1) when the questions are similar and the response is reasonable for all questions—for example, when there are 3 questions that ask “Why did you pick this option?” and the response is “price” to each, (2) when repeated answers are common across a lot of respondents, (3) when responses are just a few words, or (4) the wording is slightly different each time suggesting that the respondent independently came to that answer for each question.

Additionally, the fraudulent response determination system 102 can annotate training survey response data with suspicious open-ended indicators 710 by annotating repeated respondent indicators. Specifically, the fraudulent response determination system 102 annotates repeated respondent indicators when the same uncommon phrase is used by multiple respondents, particularly when the text is unique, unusual, or longer (e.g., more than just a few words). For example, the question asks for improvements to a mobile app and different respondents provide these responses: I would like to have in my mobile app is more security; I would like to have in my mobile app is notifications; I would like to have in my mobile app is messaging. Although the answers are different, the phrase “I would like to have in my mobile app is” is uncommon and repeated across multiple respondents' answers. However, the fraudulent response determination system 102 should not mark simple, common responses such as “check deposits” or “push notifications” or “can't think of anything” with repeated respondent indicators.

In addition, the fraudulent response determination system 102 can annotate training survey response data with suspicious open-ended indicators 710 by annotating factually impossible indicators. In particular, the fraudulent response determination system 102 annotates factually impossible indicators when training survey response data comprises a situation or claim that cannot occur or be true according to the established facts and known principles of reality. For example, the fraudulent response determination system 102 should annotate a factually impossible indicator when training survey response data comprises “Admiral” when asked the respondent's rank in the army (e.g., because Admiral is not a rank in the army).

Further, the fraudulent response determination system 102 can annotate training survey response data with suspicious open-ended indicators 710 by annotating faking knowledge indicators. Specifically, the fraudulent response determination system 102 annotates faking knowledge indicators when training survey response data does not correlate with known facts. For example, when for a question about why Rage Against the Machine is their favorite band and the training survey response data states, “I love how soothing their music is and that their lyrics are positive and upbeat.” If this is their favorite band, you′d expect them to know what their music is like (e.g., Rage Against the Machine's music is intense, with high energy sound).

Also, the fraudulent response determination system 102 can annotate training survey response data with suspicious open-ended indicators 710 by annotating plagiarized indicators. In particular, the fraudulent response determination system 102 annotates plagiarized indicators when the response appears to be plagiarized from the internet. In some cases, the fraudulent response determination system 102 utilizes a large language model to identify plagiarized information and the fraudulent response determination system 102 annotates training survey response data with plagiarized indicators corresponding to the plagiarized portions.

Moreover, the fraudulent response determination system 102 can annotate training survey response data with suspicious open-ended indicators 710 by annotating obscene indicators. Specifically, the fraudulent response determination system 102 annotates a response that is obscene for the sake of obscenity, not including mild profanity that conveys a real response.

In addition, the fraudulent response determination system 102 can annotate training survey response data with suspicious open-ended indicators 710 by annotating farcical response indicators. In particular, the fraudulent response determination system 102 annotates farcical response indicators when training survey response data comprises farcical responses that do not convey a real opinion or answer the question. For example, the fraudulent response determination system 102 annotates a farcical response indicator when training survey response data comprises a response of “Spongebob” to a question of they think should run for president.

Lastly, the fraudulent response determination system 102 can annotate training survey response data with suspicious open-ended indicators 710 by annotating artificial intelligence response indicators. Specifically, the fraudulent response determination system 102 annotates an artificial intelligence indicator when training survey response data comprises a phrase that suggests it was provided by an artificial intelligence language model. For example, the fraudulent response determination system 102 annotates when training survey response data comprises a response that is not a personal opinion or does not reflect personal experience when it should, such as “As an AI language model, I don't have any personal experiences or emotions, and can't describe my favorite type of shampoo.” As another example, the fraudulent response determination system 102 annotates when training survey response data comprises a response that is lengthy and well-written (especially compared to other responses) and usually go above and beyond what is required to answer the question. As an illustration, an artificial intelligence model may answer the question “What capabilities would you like to have on your mobile app?” with answers that include things like, “Integrate with investment platforms to provide users with a consolidated view of their investment portfolio and performance.” “Include budgeting features that categorize expenses and track spending patterns, helping users manage their finances.”

As mentioned, the fraudulent response determination system 102 utilizes the training dataset 714 comprising the annotated training survey response data to train the fraudulent-response-identifying machine-learning model. In particular, the fraudulent response determination system 102 utilizes the training dataset 714 to train the fraudulent-response-identifying machine-learning model to generate accurate fraud scores. FIG. 7B illustrates an example diagram for utilizing the training dataset to train the fraudulent-response-identifying machine-learning model with a loss function.

As illustrated in FIG. 7B, the fraudulent response determination system 102 accesses training survey response data 720. Training survey response data 720 constitutes survey response data from various digital surveys is used to train the fraudulent-response-identifying machine-learning model 716. The training survey response data 720 has a corresponding fraud determination label 722 associated with it, where the fraud determination label 722 indicates whether the training survey response data 720 was previously determined to be either a correct model selection (or hardware allocation and/or model training scheduling). For example, training survey response data 720 could be a survey response data that a team of researchers determined or confirmed as either fraudulent or not fraudulent. Accordingly, in some cases, the fraudulent response determination system 102 treats the fraud determination label 722 as a ground truth for training the fraudulent-response-identifying machine-learning model 716.

As further illustrated in FIG. 7B, the fraudulent response determination system 102 provides training dataset 714 associated with the training survey response data 720 to the fraudulent-response-identifying machine-learning model 716 and utilizes the fraudulent-response-identifying machine-learning model 716 to generate a training fraud score 718 based on the training dataset 714. As the name indicates, the training dataset 714 represent features associated with the training survey response data 720 that are used for training the fraudulent-response-identifying machine-learning model 716. Accordingly, the training dataset 714 can constitute a feature used as input for the fraudulent-response-identifying machine-learning model 716. In some embodiments, the fraudulent-response-identifying machine-learning model 716 generates training fraud score 718, including a fraud score for the training survey response data 720 and/or a label based on the fraud score. The training fraud score 718 can accordingly take the form of any of the model outputs described above.

As further illustrated in FIG. 7B, the fraudulent response determination system 102 utilizes a loss function to compare the training fraud score 718 and the fraud determination label 722 (e.g., to determine an error or a measure of loss between them). For instance, in cases where the fraudulent-response-identifying machine-learning model 716 is an ensemble of gradient-boosted trees, the fraudulent response determination system 102 utilizes a mean squared error loss function (e.g., for regression) and/or a logarithmic loss function (e.g., for classification) as the loss function 724. By contrast, in embodiments where the fraudulent-response-identifying machine-learning model 716 is a neural network, the intelligent selection and execution platform can utilize a cross-entropy loss function, an L1 loss function, or a mean squared error loss function as the loss function 724. For example, the fraudulent response determination system 102 utilizes the loss function 724 to determine a difference between the training fraud score 718 (e.g., a label based on the training fraud score 718) and the fraud determination label 722.

As further illustrated in FIG. 7B, the intelligent selection and execution platform performs model fitting 726. In particular, the fraudulent response determination system 102 fits the fraudulent-response-identifying machine-learning model 716 based on loss from the loss function 724. For instance, the fraudulent response determination system 102 performs modifications or adjustments to the fraudulent-response-identifying machine-learning model 716 to reduce the measure of loss from the loss function 724 for a subsequent training iteration.

For gradient-boosted trees, for example, the fraudulent response determination system 102 trains the fraudulent-response-identifying machine-learning model 716 on the gradients of errors determined by the loss function 724. For instance, the intelligent selection and execution platform solves a convex optimization problem (e.g., of infinite dimensions) while regularizing the objective to avoid overfitting. In certain implementations, the fraudulent response determination system 102 scales the gradients to emphasize corrections to under-represented classes (e.g., fraud classifications or non-fraud classifications).

In some embodiments, the fraudulent response determination system 102 adds a new weak learner (e.g., a new boosted tree) to the fraudulent-response-identifying machine-learning model 716 for each successive training iteration as part of solving the optimization problem. For example, the fraudulent response determination system 102 finds a feature that minimizes a loss from the loss function 724 and either adds the feature to the current iteration's tree or starts to build a new tree with the feature

In addition to, or in the alternative, gradient-boosted decision trees, the fraudulent response determination system 102 trains a logistic regression to learn parameters for generating one or more fraud predictions, such as a fraud score indicating a probability of fraud. To avoid overfitting, the fraudulent response determination system 102 further regularizes based on hyperparameters such as the learning rate, stochastic gradient boosting, the number of trees, the tree depth(s), complexity penalization, and L1/L2 regularization.

In embodiments where the fraudulent-response-identifying machine-learning model 716 is a neural network, the fraudulent response determination system 102 performs the model fitting 726 by modifying internal parameters (e.g., weights) of the fraudulent-response-identifying machine-learning model 716 to reduce the measure of loss for the loss function 724. Indeed, the fraudulent response determination system 102 modifies how the fraudulent-response-identifying machine-learning model 716 analyzes and passes data between layers and neurons by modifying the internal network parameters. Thus, over multiple iterations, the fraudulent response determination system 102 improves the accuracy of the fraudulent-response-identifying machine-learning model 716.

Indeed, in some cases, the fraudulent response determination system 102 repeats the training process illustrated in FIG. 7B for multiple iterations. For example, the fraudulent response determination system 102 repeats the iterative training by selecting a new set of training features for each training digital claim along with a corresponding fraud action label. The fraudulent response determination system 102 further generates a new set of training fraud predictions for each iteration. As described above, the fraudulent response determination system 102 also compares a training fraud prediction at each iteration with the corresponding training action label and further performs model fitting 726. The fraudulent response determination system 102 repeats this process until the fraudulent-response-identifying machine-learning model 716 generates training fraud predictions that result in fraud predictions that satisfy a threshold measure of loss.

As previously mentioned, the fraudulent response determination system 102 can receive a data scrub request. In particular, the fraudulent response determination system 102 can receive a data scrub request that instructs the fraudulent response determination system 102 to identify and remove fraudulent survey response data. FIGS. 8A-8B illustrate example graphical user interfaces for receiving data scrub requests and managing responses of a digital survey in accordance with one or more embodiments. Specifically, FIG. 8A illustrates an example graphical user interface for receiving a data scrub request and FIG. 8B illustrates an example graphical user interface for managing data scrubbing of survey response data.

As shown in FIG. 8A, fraudulent response determination system 102 can render graphical user interface 800 for managing digital survey responses. In particular, the fraudulent response determination system 102 or the digital survey system 104 renders, or causes an administrator client device to render, graphical user interface 800 for managing a response from a digital survey. For example, within graphical user interface, the administrator client device views responses received, survey response data, or other data from the digital survey and provides input for managing the digital survey.

As also shown in FIG. 8A, graphical user interface 800 comprises an element 802 for displaying responses received. For example, element 802 displays the total of number of responses for the digital survey that the digital survey system 104 has received to this point (e.g., at the most recent refresh of the digital survey system). Further, as shown in FIG. 8A, graphical user interface 800 comprises an element 804 for displaying a target number of responses for the digital survey. For example, element 804 displays a target number of responses for the digital survey that an administrator client device provides to the digital survey system 104 when generating (e.g., setting up) the digital survey.

Moreover, as shown in FIG. 8A, graphical user interface 800 comprises an element 806 for displaying a visual completion element of the digital survey. In particular, element 806 displays a visual display of the completion rate of the digital survey. For example, element 806 visually displays an amount of the digital survey that is completed and/or a portion of the digital survey not completed. In some cases, as illustrated, the graphical user interface 800 displays element 806 by displaying a bar graph that indicates the completion rate of the digital survey. In other cases, graphical user interface 800 displays another visual indicator, such as a pie chart. In additional cases, graphical user interface 800 displays a numerical indicator that indicates the completion rate of the digital survey.

As previously mentioned, the fraudulent response determination system 102 can generate a fraud score (or determine fraud indicators) in response to receiving a data scrub request. Specifically, the fraudulent response determination system 102 receives a data scrub request from an administrator client device. As shown, graphical user interface 800 comprises an element 808 for receiving a user indication of a data scrub request. For example, the fraudulent response determination system 102 receives, within graphical user interface 800, an indication of an user selection of element 808 for a data scrub request.

As also shown, the fraudulent response determination system 102 displays element 810, element 812, and element 814 indicating potentially fraudulent survey response data. In particular, graphical user interface displays element 810 for fraudulent survey response data, element 812 for suspicious survey response data, and element 814 for mild survey response data. For example, element 810 represents survey response data associated with a fraudulent label, element 812 represents survey response data associated with a suspicious label, and element 614 represents survey response data associated with a mild label. In some cases, fraudulent response determination system 102 displays element 810, element 812, and/or element 814 prior to receiving an indication of the element 808, as an indication of a number of instances of potentially fraudulent survey response data that the fraudulent response determination system 102 would remove from a dataset upon receiving a data scrub request. In other cases, the fraudulent response determination system 102 displays element 810, element 812, and/or element 814 after receiving an indication of a data scrub request, as an indication of a number of instances of potentially fraudulent survey response data removed from a dataset in response to receiving a data scrub request.

In one or more embodiments, the fraudulent response determination system 102 displays options for managing data scrubbing of responses of digital surveys. In particular, the fraudulent response determination system 102 can receive indications of preferences for removing survey response data that the fraudulent response determination system 102 determines is fraudulent. FIG. 8B illustrates an example graphical user interface for managing data scrubbing of survey response data.

As shown in FIG. 8B, the fraudulent response determination system 102 displays, within graphical user interface 800, an element 816 for indicating a preference for the fraudulent response determination system 102 to check for fraudulent survey response data upon receiving a response. Specifically, based on the selection of element 816, the fraudulent response determination system 102 generates a fraud score (or determines fraud indicators) for survey response data of a digital survey in response to receiving the response associated with the survey response data. For example, the fraudulent response determination system 102 utilizes the fraud indicator identifying algorithm or the fraudulent-response-identifying machine-learning model in response to receiving a response to a digital survey from a respondent client device.

As also shown in FIG. 8B, the fraudulent response determination system 102 displays, within graphical user interface 800, an element 818 for indicating a preference to check for fraudulent survey response data when the digital survey is a percentage complete. Specifically, based on the selection of element 818, the fraudulent response determination system 102 performs a data scrubbing operation on survey response data associated with responses of the digital survey. For example, when element 818 is selected, the fraudulent response determination system 102 will perform a data scrubbing operation on survey response data without receiving a data scrub request and without human intervention when the fraudulent response determination system 102 determines that the digital survey is the percentage completed indicated in element 818.

Moreover, as illustrated in FIG. 8B, the fraudulent response determination system 102 displays, within graphical user interface 800, an element 820 for indicating the fraudulent response determination system 102 perform a data scrubbing operation when prompted. In particular, based on a selection of element 820, the fraudulent response determination system 102 will perform a data scrubbing operation upon receiving a data scrub request (e.g., receiving a selection of element 808). For example, the fraudulent response determination system 102 will abstain from performing a data scrub request in response to a selection of element 820.

In one or more embodiments, the fraudulent response determination system 102 updates a dataset of responses based on a user preference. In particular, the fraudulent response determination system 102 can receive a selection of element 822 to remove survey response data with a fraudulent label. For example, based on the selection of element 822, the fraudulent response determination system 102 will remove survey response data with a fraudulent label when performing a data scrubbing operation. Further, the fraudulent response determination system 102 can remove survey response data with a suspicious label based on a selection of element 824 or remove survey response data with a mild label based on a selection of element 826.

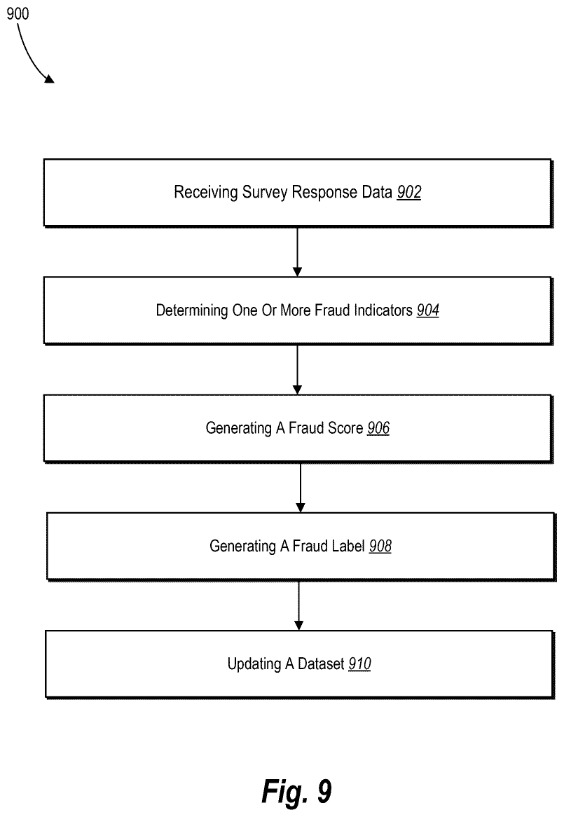

FIGS. 1-8, the corresponding text, and the examples provide a number of different methods, systems, devices, and non-transitory computer-readable media of the fraudulent response determination system 102. In addition to the foregoing, one or more embodiments can also be described in terms of flowcharts comprising acts for accomplishing a particular result, as shown in FIG. 9. FIG. 9 may be performed with more or fewer acts. Further, the acts may be performed in differing orders. Additionally, the acts described herein may be repeated or performed in parallel with one another or parallel with different instances of the same or similar acts.

As mentioned, FIG. 9 illustrates a flowchart of a series of acts 900 for generating a fraud score and updating a dataset of responses to a digital survey in accordance with one or more embodiments. While FIG. 9 illustrates acts according to one embodiment, alternative embodiments may omit, add to, reorder, and/or modify any of the acts shown in FIG. 9. The acts of FIG. 9 can be performed as part of a method. Alternatively, a non-transitory computer-readable medium can comprise instructions that, when executed by one or more processors, cause a computing device to perform the acts of FIG. 9. In some embodiments, a system can perform the acts of FIG. 9.

As shown in FIG. 9, the series of acts 900 includes an act 902 of receiving survey response data, an act 904 of determining one or more fraud indicators, an act 906 of generating a fraud score, an act 908 of generating a label, and an act 910 of updating a dataset.

In particular, the act 902 can include receive survey response data associated with a response of a digital survey, wherein the survey response data corresponds to a respondent client device, the act 904 can include determining, in response to a data scrub request, one or more fraud indicators from the survey response data according to one or more attributes of the survey response data, the act 906 can include in response to determining the one or more fraud indicators from the survey response data, generating a fraud score for the survey response data indicating a probability that the survey response data includes fraudulent data, the act 908 can include generate a label for the survey response data based on the fraud score, and the act 910 can include update a dataset including a plurality of responses of the digital survey based on the label for the survey response data.

For example, in one or more embodiments, the series of acts 900 includes generating the label for the survey response data by generating a fraudulent label for the survey response data based on the fraud score satisfying a fraudulent response threshold; and based on generating the fraudulent label for the survey response data, updating the dataset by removing the survey response data from the plurality of responses of digital survey. In addition, in one or more embodiments, the series of acts 900 includes generating an indicator score for each of the one or more fraud indicators; and generate the fraud score based on the indicator score for each of the one or more fraud indicators.

Also, in one or more embodiments, the series of acts 900 includes determining that the digital survey satisfies a digital survey completion threshold based on receiving a threshold number of survey response associated with the digital survey; receive, from an administrator client device, the data scrub request to perform a data scrubbing operation on responses associated with the digital survey in response to determining that the digital survey satisfies the digital survey completion threshold; and determining the one or more fraud indicators from the survey response data in response to receiving the data scrub request. Moreover, in one or more embodiments, the series of acts 900 includes determining the one or more fraud indicators in response to receiving the survey response data from the respondent client device.

Further, in one or more embodiments, the series of acts 900 includes determining that at least one fraud indicator of the one or more fraud indicators comprises a fraudulent response indicator; in response to determining that the at least one fraud indicator comprises the fraudulent response indicator, generate the fraud score to satisfy a fraudulent response threshold; and remove the survey response data from a dataset of responses for the digital survey based on generating the fraud score to satisfy the fraudulent response threshold. In addition, in one or more embodiments, the series of acts 900 includes determining the one or more fraudulent response indicators by identifying a user identification indicator, a survey page time indicator, a duplicate open-ended response indicator, a multiple option selection indicator, a flatlining selection indicator, a zip code indicator, an internet protocol (IP) address indicator, a duplicate location indicator, a numerical outlier indicator, a non-insightful response indicator, a repeated text indicator, or a country indicator.

In addition, in one or more embodiments, the series of acts 900 includes generating a prompt comprising the survey response data and an instruction to generate a response indicating whether the survey response data includes the one or more fraud indicators; and determine the one or more fraud indicators from the survey response data by providing the prompt to a large language model to generate the response. Moreover, in one or more embodiments, the series of acts 900 includes generating a prompt comprising the survey response data and an instruction to generate a response comprising demographic information from the survey response data; provide the prompt to a large language model to generate the demographic information from the survey response data; and determine the one or more fraud indicators from the survey response data utilizing the demographic information.

In addition, in one or more embodiments, the series of acts 900 includes receiving survey response data associated with a response of a digital survey, wherein the survey response data corresponds to a respondent client device; determining, utilizing a fraud indicator identification algorithm, one or more fraud indicators from the survey response data according to a set of fraud indicator rules and one or more attributes of the survey response data; in response to determining the one or more fraud indicators, generating a fraud score for the survey response data indicating a probability that the survey response data includes fraudulent data; based on the fraud score, generating a label for the survey response data by generating a fraudulent label indicating that the survey response data comprises fraudulent data; and in response to generating the fraudulent label, removing the survey response data from a dataset including a plurality of responses of the digital survey.

Moreover, in one or more embodiments, the series of acts 900 includes determining, in response to the data scrub request, one or more additional fraud indicators from additional survey response data according to one or more attributes of the additional survey response data; in response to determining the one or more fraud indicators, generating an additional fraud score for the additional survey response data indicating a probability that the survey response data includes fraudulent data; and based on the additional fraud score, generating an additional label for the additional survey response data by generating a fraudulent label indicating that the additional survey response data is fraudulent; a suspicious label indicating that the additional survey response data may be fraudulent, or a mild label indicating that the additional survey response data is not fraudulent.

In addition, in one or more embodiments, the series of acts 900 includes generating the label for the survey response data by generating a fraudulent label indicating the survey response data is fraudulent; and removing the survey response data form the dataset of responses of the digital survey based on generating the fraudulent label.

Also, in one or more embodiments, the series of acts 900 includes determining, utilizing the fraud indicator identification algorithm, that a portion of the survey response data is artificially generated via computer-executable instructions based on the one or more attributes of the survey response data and generating the fraud score based in part on determining that the portion of the survey response data is artificially generated.

In addition, in one or more embodiments, the series of acts 900 includes utilizing the fraud indicator identifying algorithm to identify one or more fraudulent response indicators by identifying: a user identification indicator, a survey page time indicator, a duplicate open-ended response indicator, a multiple option selection indicator, a flatlining selection indicator, a zip code indicator, an internet protocol (IP) address indicator, a duplicate location indicator, a numerical outlier indicator, a non-insightful response indicator, a repeated text indicator, or a country indicator.

Moreover, in one or more embodiments, the series of acts 900 includes generating a prompt comprising the survey response data and an instruction to generate a response indicating whether the survey response data includes the one or more fraud indicators; and determining the one or more fraud indicators from the survey response data by providing the prompt to a large language model to generate the response.

Further, in one or more embodiments, the series of acts 900 includes receiving survey response data associated with a response of a digital survey, wherein the survey response data corresponds to a respondent client device; generating, utilizing a fraudulent-response-identifying machine-learning model, a fraud score for the survey response data indicating a probability that the survey response data includes fraudulent data; based on the fraud score, generating a label for the survey response data by generating a fraudulent label indicating that the survey response data is fraudulent; and based on the label corresponding to a fraudulent label, removing the survey response data from a dataset including a plurality of responses of the digital survey.

Moreover, in one or more embodiments, the series of acts 900 includes generating a training dataset comprising annotated survey response data by annotating training survey responses with fraud determination indications; modifying, utilizing the training dataset, parameters of the fraudulent-response-identifying machine-learning model;

Further, in one or more embodiments, the series of acts 900 includes receiving, from an administrator device associated with the digital survey, an indication that the survey response data is fraudulent; and updating parameters of the fraudulent-response-identifying machine-learning model based on the indication that the survey response data is fraudulent. Also, in one or more embodiments, the series of acts 900 includes providing the survey response data to the fraudulent-response-identifying machine-learning model to generate the fraud score in response to receiving the survey response data from the respondent client device; and removing the survey response data from the dataset upon generating the label and without determining that the digital survey satisfies a digital survey completion threshold.

Also, in one or more embodiments, the series of acts 900 includes determining, utilizing the fraudulent-response-identifying machine-learning model, that additional survey response data for the digital survey corresponds to the respondent client device; generating the fraud score to satisfy a fraudulent response threshold based on determining that the additional survey response data corresponds to the respondent client device; and removing the survey response data from the dataset in response to generating the fraud score to satisfy the fraudulent response threshold.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 10 illustrates a block diagram of an example computing device 1000 that may be configured to perform one or more of the processes described above. One will appreciate that one or more computing devices, such as the computing device 1000 may represent the computing devices described above (e.g., server(s) 106, respondent client devices 108a-108n, or administrator client device 112). In one or more embodiments, the computing device 1000 may be a mobile device (e.g., a mobile telephone, a smartphone, a PDA, a tablet, a laptop, a camera, a tracker, a watch, a wearable device, etc.). In some embodiments, the computing device 1000 may be a non-mobile device (e.g., a desktop computer or another type of client device). Further, the computing device 1000 may be a server device that includes cloud-based processing and storage capabilities.

As shown in FIG. 10, the computing device 1000 can include one or more processor(s) 1002, memory 1004, a storage device 1006, input/output interfaces 1008 (or “I/O interfaces 1008”), and a communication interface 1010, which may be communicatively coupled by way of a communication infrastructure (e.g., bus 1012). While the computing device 1000 is shown in FIG. 10, the components illustrated in FIG. 10 are not intended to be limiting. Additional or alternative components may be used in other embodiments. Furthermore, in certain embodiments, the computing device 1000 includes fewer components than those shown in FIG. 10. Components of the computing device 1000 shown in FIG. 10 will now be described in additional detail.

In particular embodiments, the processor(s) 1002 includes hardware for executing instructions, such as those making up a computer program. As an example, and not by way of limitation, to execute instructions, the processor(s) 1002 may retrieve (or fetch) the instructions from an internal register, an internal cache, memory 1004, or a storage device 1006 and decode and execute them.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1004 may be internal or distributed memory.

The computing device 1000 includes a storage device 1006 includes storage for storing data or instructions. As an example, and not by way of limitation, the storage device 1006 can include a non-transitory storage medium described above. The storage device 1006 may include a hard disk drive (HDD), flash memory, a Universal Serial Bus (USB) drive or a combination these or other storage devices.

As shown, the computing device 1000 includes one or more I/O interfaces 1008, which are provided to allow a user to provide input to (such as user strokes), receive output from, and otherwise transfer data to and from the computing device 1000. These I/O interfaces 1008 may include a mouse, keypad or a keyboard, a touch screen, camera, optical scanner, network interface, modem, other known I/O devices or a combination of such I/O interfaces 1008. The touch screen may be activated with a stylus or a finger.

The I/O interfaces 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1008 are configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 provides one or more interfaces for communication (such as, for example, packet-based communication) between the computing device and one or more other computing devices or one or more networks. As an example, and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can include hardware, software, or both that connects components of computing device 1000 to each other.

FIG. 11 illustrates an example network environment 1100 of a digital survey management system 1102 (e.g., the digital survey system 104, including the fraudulent response determination system 102). The network environment 1100 includes a digital survey management system 1102 and a client device 1106, connected to each other by a network 1104. Although FIG. 9 illustrates a particular arrangement of the client device 1106, the digital survey management system 1102, and the network 1104, this disclosure contemplates any suitable arrangement of the client device 1106, the digital survey management system 1102, and the network 1104. As an example, and not by way of limitation, two or more of the client device 1106 and the digital survey management system 1102 communicate directly, bypassing the network 1104. As another example, two or more of the client device 1106 and the digital survey management system 1102 may be physically or logically co-located with each other in whole or in part. Moreover, although FIG. 9 illustrates a particular number of the client device 1106, the digital survey management system 1102, and the network 1104, this disclosure contemplates any suitable number of client devices 1106, digital survey management system 1102, and networks 1104. As an example, and not by way of limitation, the network environment 1100 may include multiple client devices 1106, multiple digital survey management system 1102, and multiple networks 1104.

This disclosure contemplates any suitable network 1104. As an example, and not by way of limitation, one or more portions of the network 1104 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. The network 1104 may include one or more networks 1104.

Links may connect the client device 1106 and the digital survey management system 1102 to the network 1104 or to each other. This disclosure contemplates any suitable links. In particular embodiments, one or more links include one or more wireline (such as, for example, Digital Subscriber Line (“DSL”) or Data Over Cable Service Interface Specification (“DOCSIS”)), wireless (such as, for example, Wi-Fi or Worldwide Interoperability for Microwave Access (“WiMAX”)), or optical (such as, for example, Synchronous Optical Network (“SONET”) or Synchronous Digital Hierarchy (“SDH”)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout the network environment 1100. One or more first links may differ in one or more respects from one or more second links.

In particular embodiments, the client device 1106 may be an electronic device including hardware, software, or embedded logic components or a combination of two or more such components and capable of carrying out the appropriate functionalities implemented or supported by the client device 1106. As an example, and not by way of limitation, a client device 1106 may include any of the computing devices discussed above in relation to FIG. 8. A client device 1106 may enable a network user at the client device 1106 to access a network. A client device 1106 may enable its user to communicate with other users at other client devices 1106. A client device 1106 can be the administrator client device 112. A client device 1106 can be the user respondent client device(s) 108a-108n. A client device 1106 can include both the administrator client device 112 and the user respondent client device(s) 108a-108n.

In particular embodiments, the client device 1106 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1106 may enter a Uniform Resource Locator (“URL”) or other address directing the web browser to a particular server (such as the server(s) 106), and the web browser may generate a Hyper Text Transfer Protocol (“HTTP”) request and communicate the HTTP request to the server. The server may accept the HTTP request and communicate to the client device 1106 one or more Hyper Text Markup Language (“HTML”) files responsive to the HTTP request. The client device 1106 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

The digital survey management system 1102 may be accessed by the other components of the network environment 1100 either directly or via network 1104. In particular embodiments, the digital survey management system 1102 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the digital survey management system 1102 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable the client device 1106 or the digital survey management system 1102 to manage, retrieve, modify, add, or delete, the information stored in data storage.

In particular embodiments, the digital survey management system 1102 may be capable of linking a variety of entities. As an example, and not by way of limitation, the digital survey management system 1102 may enable multiple users and/or agents to interact with each other or other entities, or to allow users and/or agents to interact with these entities through an application programming interface (“API”) or other communication channels.

In particular embodiments, the digital survey management system 1102 may include a variety of servers, sub-systems, programs, modules, logs, and data stores. In particular embodiments, the digital survey management system 1102 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The digital survey management system 1102 may also include suitable components such as network interfaces, security mechanisms, load balancers, failover servers, management-and-network-operations consoles, other suitable components, or any suitable combination thereof.

In particular embodiments, the digital survey management system 1102 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. Additionally, a user profile may include financial and billing information of users (e.g., customers, etc.).

The web server may include a mail server or other messaging functionality for receiving and routing messages between the digital survey management system 1102 and one or more client devices 1106. An action logger may be used to receive communications from a web server about a user's actions on or off the digital survey management system 1102. In conjunction with the action log, a third-party-content-object log may be maintained of user exposures to third-party-content objects. A notification controller may provide information regarding content objects to the client device 1106. Information may be pushed to the client device 1106 as notifications, or information may be pulled from the client device 1106 responsive to a request received from the client device 1106. Authorization servers may be used to enforce one or more privacy settings of the users of the digital survey management system 1102. A privacy setting of a user determines how particular information associated with a user can be shared. The authorization server may allow users to opt in to or opt out of having their actions logged by the digital survey management system 1102 or shared with other systems, such as, for example, by setting appropriate privacy settings. Third-party-content-object stores may be used to store content objects received from third parties. Location stores may be used for storing location information received from the client devices 1106 associated with users.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

1. A system comprising:
at least one processor; and
at least one non-transitory computer-readable storage medium storing instructions that, when executed by the at least one processor, cause the system to:
receive survey response data associated with a response of a digital survey, wherein the survey response data corresponds to a respondent client device;
determine, in response to a data scrub request and utilizing a fraud indicator identifying algorithm, one or more fraud indicators from the survey response data according to one or more attributes of the survey response data, wherein each of the one or more fraud indicators represent a signal identified in the survey response data indicating a likelihood that the survey response data comprises fraudulent information;
generate, in response to the data scrub request and in parallel with determining the one or more fraud indicators, one or more additional fraud indicators by utilizing a large language model to analyze the survey response data and generate a synthesized output comprising the one or more additional fraud indicators;
based on the one or more fraud indicators and the one or more additional fraud indicators, generate a fraud score for the survey response data indicating a probability that the survey response data includes fraudulent data;
generate a label for the survey response data based on the fraud score; and
update a dataset including a plurality of responses of the digital survey based on the label for the survey response data.

2. The system of claim 1, further comprising instructions that, when executed by the at least one processor, cause the system to:
generate the label for the survey response data by generating a fraudulent label for the survey response data based on the fraud score satisfying a fraudulent response threshold; and
based on generating the fraudulent label for the survey response data, updating the dataset by removing the survey response data from the plurality of responses of digital survey.

3. The system of claim 1, further comprising instructions that, when executed by the at least one processor, cause the system to:
generate an indicator score for each of the one or more fraud indicators; and
generate the fraud score based on the indicator score for each of the one or more fraud indicators.

4. The system of claim 1, further comprising instructions that, when executed by the at least one processor, cause the system to:
determine that the digital survey satisfies a digital survey completion threshold based on receiving a threshold number of survey responses associated with the digital survey;
receive, from an administrator client device, the data scrub request to perform a data scrubbing operation on responses associated with the digital survey in response to determining that the digital survey satisfies the digital survey completion threshold; and
determining the one or more fraud indicators from the survey response data in response to receiving the data scrub request.

5. The system of claim 1, further comprising instructions that, when executed by the at least one processor, cause the system to determine the one or more fraud indicators in response to receiving the survey response data from the respondent client device.

6. The system of claim 1, further comprising instructions that, when executed by the at least one processor, cause the system to:
determine that at least one fraud indicator of the one or more fraud indicators comprises a fraudulent response indicator;
in response to determining that the at least one fraud indicator comprises the fraudulent response indicator, generate the fraud score to satisfy a fraudulent response threshold; and
remove the survey response data from a dataset of responses for the digital survey based on generating the fraud score to satisfy the fraudulent response threshold.

7. The system of claim 1, further comprising instructions that, when executed by the at least one processor, cause the system to determine the one or more fraud indicators by identifying a user identification indicator, a survey page time indicator, a duplicate open-ended response indicator, a multiple option selection indicator, a flatlining selection indicator, a zip code indicator, an internet protocol (IP) address indicator, a duplicate location indicator, a numerical outlier indicator, a non-insightful response indicator, a repeated text indicator, or a country indicator.

8. The system of claim 1, further comprising instructions that, when executed by the at least one processor, cause the system to:
generate a prompt comprising the survey response data and an instruction to generate a response indicating whether the survey response data includes the one or more fraud indicators; and
determine the one or more fraud indicators from the survey response data by providing the prompt to the large language model to generate the response.

9. The system of claim 1, further comprising instructions that, when executed by the at least one processor, cause the system to:
generate a prompt comprising the survey response data and an instruction to generate a response comprising demographic information from the survey response data;
provide the prompt to the large language model to generate the demographic information from the survey response data; and
determine the one or more fraud indicators from the survey response data utilizing the demographic information.

10. A non-transitory computer-readable medium storing instructions that, when executed by at least one processor, cause a computer system to:
receive survey response data associated with a response of a digital survey, wherein the survey response data corresponds to a respondent client device;
determine, utilizing a fraud indicator identification algorithm, one or more fraud indicators from the survey response data according to a set of fraud indicator rules and one or more attributes of the survey response data, wherein each of the one or more fraud indicators represent a signal identified in the survey response data indicating a likelihood that the survey response data comprises fraudulent information;
generate, in parallel with determining the one or more fraud indicators, one or more additional fraud indicators by utilizing a large language model to analyze the survey response data generate a synthesized output comprising the one or more additional fraud indicators;
based on the one or more fraud indicators and the one or more additional fraud indicators, generate a fraud score for the survey response data indicating a probability that the survey response data includes fraudulent data;
based on the fraud score, generate a label for the survey response data by generating a fraudulent label indicating that the survey response data comprises fraudulent data; and
in response to generating the fraudulent label, remove the survey response data from a dataset including a plurality of responses of the digital survey.

11. The non-transitory computer-readable medium of claim 10, further comprising instructions that, when executed by the at least one processor, cause the computer system to:
determine, based on receiving additional survey response data, one or more additional fraud indicators from the additional survey response data according to one or more attributes of the additional survey response data;
in response to determining the one or more fraud indicators, generate an additional fraud score for the additional survey response data indicating a probability that the survey response data includes fraudulent data; and
based on the additional fraud score, generate an additional label for the additional survey response data by generating a fraudulent label indicating that the additional survey response data is fraudulent, a suspicious label indicating that the additional survey response data may be fraudulent, or a mild label indicating that the additional survey response data is not fraudulent.

12. The non-transitory computer-readable medium of claim 10, further comprising instructions that, when executed by the at least one processor, cause the computer system to:
generate the label for the survey response data by generating a fraudulent label indicating the survey response data is fraudulent; and
remove the survey response data form the dataset of responses of the digital survey based on generating the fraudulent label.

13. The non-transitory computer-readable medium of claim 10, further comprising instructions that, when executed by the at least one processor, cause the computer system to:
determine, utilizing the fraud indicator identification algorithm, that a portion of the survey response data is artificially generated via computer-executable instructions based on the one or more attributes of the survey response data; and
generate the fraud score based in part on determining that the portion of the survey response data is artificially generated.

14. The non-transitory computer-readable medium of claim 10, further comprising instructions that, when executed by the at least one processor, cause the computer system to utilize the fraud indicator identification algorithm to identify one or more fraudulent response indicators by identifying: a user identification indicator, a survey page time indicator, a duplicate open-ended response indicator, a multiple option selection indicator, a flatlining selection indicator, a zip code indicator, an internet protocol (IP) address indicator, a duplicate location indicator, a numerical outlier indicator, a non-insightful response indicator, a repeated text indicator, or a country indicator.

15. The non-transitory computer-readable medium of claim 10, further comprising instructions that, when executed by the at least one processor, cause the computer system to:
generate a prompt comprising the survey response data and an instruction to generate a response indicating whether the survey response data includes the one or more fraud indicators; and
determine the one or more fraud indicators from the survey response data by providing the prompt to the large language model to generate the response.

16. A computer-implemented method comprising:
receiving survey response data associated with a response of a digital survey, wherein the survey response data corresponds to a respondent client device;
generating, utilizing a fraudulent-response-identifying machine-learning model, a fraud score for the survey response data indicating a probability that the survey response data includes fraudulent data, wherein the fraud score is based on one or more fraud indicators in the survey response data that represent a signal identified in the survey response data indicating a likelihood that the survey response data comprises fraudulent information;
generating, in parallel with generating the fraud score, an additional fraud score by:
utilizing a large language model to analyze the survey response data and generate a synthesized output comprising one or more additional fraud indicators; and
generating the additional fraud score based on the one or more additional fraud indicators;
based on the fraud score and the additional fraud score, generating a label for the survey response data by generating a fraudulent label indicating that the survey response data is fraudulent; and
based on the label corresponding to the fraudulent label, removing the survey response data from a dataset including a plurality of responses of the digital survey.

17. The computer-implemented method of claim 16, further comprising:
generating a training dataset comprising annotated survey response data by annotating training survey responses with fraud determination indications; and
modifying, utilizing the training dataset, parameters of the fraudulent-response-identifying machine-learning model.

18. The computer-implemented method of claim 16, further comprising:
receiving, from an administrator device associated with the digital survey, an indication that the survey response data is fraudulent; and
updating parameters of the fraudulent-response-identifying machine-learning model based on the indication that the survey response data is fraudulent.

19. The computer-implemented method of claim 16, further comprising:
providing the survey response data to the fraudulent-response-identifying machine-learning model to generate the fraud score in response to receiving the survey response data from the respondent client device; and
removing the survey response data from the dataset upon generating the label and without determining that the digital survey satisfies a digital survey completion threshold.

20. The computer-implemented method of claim 16, further comprising:
determining, utilizing the fraudulent-response-identifying machine-learning model, that additional survey response data for the digital survey corresponds to the respondent client device;
generating the fraud score to satisfy a fraudulent response threshold based on determining that the additional survey response data corresponds to the respondent client device; and
removing the survey response data from the dataset in response to generating the fraud score to satisfy the fraudulent response threshold.
